(19) United States
(12) Patent Application Publication
(10) Pub. No.: US 2006/0202933 A1
(43) Pub. Date: Sep. 14, 2006

(54) Picture element using microelectromechanical switch

(76) Inventors: Nicholas F. Pasch, Pacifica, CA (US); Michael D. Sauvante, Santa Barbara, CA (US); Glenn C. Sanders, Mountain View, CA (US); Kazuo Senda, Tatebayashi-City (JP); Hajime Seki, San Jose, CA (US)

Correspondence Address: Trellis Intellectual Property Law Group, PC, 1900 EMBARCADERO ROAD, SUITE 109, PALO ALTO, CA, 94303, US

(21) Appl. No.: 11/361,314

(22) Filed: Feb. 24, 2006

Related U.S. Application Data
(60) Provisional application No. 60/656,855, filed on Feb. 25, 2005.

(51) Int. Cl. G09G 3/36

(52) U.S. Cl. 345/94

(57) ABSTRACT

A robust microelectromechanical switch. In an illustrative embodiment, the switch is adapted for use in a display and includes a first flexible surface and a second surface. The second surface is angled relative to the first surface, forming a wedge the first surface and the second surface. A first terminal and a second terminal are positioned relative to the first flexible surface and the second surface so that selective flexing of the flexible surface electrically couples or uncouples the first terminal to the second terminal. In a more specific embodiment, the switch further includes a first mechanism for selectively applying an electrostatic force between the first flexible surface and the second surface. The first surface is positioned on a first elastic flexible layer, and the second surface is positioned on a second layer. The first mechanism includes a first actuator electrode that is coupled to the first surface, and a second actuator electrode that is coupled to the second surface. A sufficient charge differential applied between the first actuator electrode and the second actuator electrode will attract the first electrode to the second electrode, thereby flexing the flexible layer toward the second layer. The sidewalls define a perimeter of a cell that houses the switch. A protrusion extends from a third layer between the sidewalls, thereby indenting the first layer, and thereby forming the wedge.

### CLAIM OF PRIORITY

This invention claims priority from commonly assigned U.S. Provisional Patent Application Ser. No. 60/656,855, entitled MICRO-ELECTROMECHANICAL SWITCH, filed on Feb. 25, 2005, which is hereby incorporated by reference as if set forth in full in this application for all purposes.

### BACKGROUND OF THE INVENTION

This invention is related in general to switches and more specifically to electrically controllable switches suitable for controlling optical devices, such as pixels of a display.

Displays, including passive and active matrix Liquid Crystal Displays (LCDs) and plasma displays, are employed in various demanding applications, including cell phone screens, electric billboards, televisions, calculator screens, wristwatch screens, and electronic paper. Such applications often demand robust cost-effective display cells, often called picture elements, or “pixels,” that can be employed to reliably produce images when combined in a display.

Design and manufacture of pixel mechanisms can be particularly important yet difficult to achieve in emerging applications requiring flexible displays. In such applications, bending may place additional stresses on display components. Previous approaches to creating sufficiently thin, lightweight, and flexible display screens have been inhibited by conventional pixel designs and manufacturing techniques.

### SUMMARY OF EMBODIMENTS OF THE INVENTION

A preferred embodiment of the present invention implements a MicroElectroMechanical (MEM) switch suitable for use in a display. The switch includes a first flexible surface and a second surface that is angled relative to the first surface, forming a wedge therebetween. A first terminal and a second terminal are positioned relative to the first flexible surface and the second surface so that selective flexing of the flexible surface electrically couples or uncouples the first terminal to the second terminal.

In a specific embodiment, the switch further includes a first mechanism for selectively applying an electrostatic force between the first flexible surface and the second surface. The first surface is positioned on a first elastic flexible layer, and the second surface is positioned on a second layer. The flexible layer includes a polymer material. The first mechanism further includes a first actuator electrode that is coupled to the first surface and a second actuator electrode coupled to the second surface.

A third layer is positioned on one side of the first layer. The second layer is positioned on a side of the first layer that is opposite the third layer. Sidewalls separate a portion of the first layer and a portion of the second layer. The sidewalls define a perimeter of a cell within which the switch and accompanying terminals are positioned. The walls are positioned to further separate the third layer from the second layer at the walls. A protrusion extends from the third layer between the walls, thereby indenting the first layer, and thereby forming the wedge.

Insertion of the protrusion according to certain embodiments of the present invention causes the first flexible layer to come into intimate or near-intimate contact with the second layer. This enhances the selective electrostatic attraction between the flexible layer and the second layer and brings electrical contacts closer together. This reduces the volume of gas that must be displaced during actuation of the flexible layer. These aspects can improve switch times and reduce energy consumption during switch operation.

Furthermore, strategic use of the protrusion may reduce bending sensitivity of the switch, which may also be called a cell. Consequently, accompanying switches may employ materials with higher elastic moduli for the first layer and materials with lower elastic moduli for the second layer, thereby enhancing manufacturing versatility and enhancing cell robustness. Furthermore, use of the protrusion may enable use of more flexible cell backplanes. Additional benefits are achieved in terms of enhanced manufacturing margins.

Furthermore, reductions in cell sizes are possible, partially resulting from the splitting of existing cells into smaller cells via use of the protrusion as discussed more fully below. Furthermore, cells constructed according to certain embodiments of the present invention may be significantly less constrained by the flatness of the substrate upon which the cells are positioned.

Additional embodiments of the present invention include a first embodiment corresponding to a display system. The display system includes a micro electromechanical system (MEMS) switch; an electrophoretic display material coupled to the switch; and an array decoder coupled to the switch and the electrophoretic display material, the array decoder being configured to detect a touched pixel location.

A second embodiment represents a sign display system that includes a flat panel display (FPD) and a secure memory component, wherein the secure memory component is configured to store information for controlling display contents on the FPD.

A third embodiment represents a switch arrangement that includes a substantially parallel arrangement of a first power, ground, and a second power, wherein the first and second powers each include a plurality of via structures and a light emitting diode (LED) device is substantially aligned with the ground and the first power.

A fourth embodiment represents a switch array that includes a plurality of switch cell structures and an electrically conductive plate structure, wherein the electrically conductive plate structure is configured to operate as a gettering material for contamination of the plurality of switch cell structures.

A fifth embodiment represents a switch that includes a column structure, such as a protrusion, a flexible layer, and a fixed electrode layer, also called a second layer, wherein the column structure is configured to be substantially in contact with the fixed electrode layer.

A sixth embodiment represents a switch array element that includes a reactive gettering film deposited on a component layer of the switch array element, wherein a normal operation of the switch array element is not substantially altered.

A seventh embodiment represents a switch that includes a plurality of layers and a scintillation material, wherein the scintillation material is configured to convert incoming actinic photons into charge cascades between at least two of the plurality of layers.

An eighth embodiment represents a MEM switch structure that includes a plurality of layers, wherein at least one of the plurality of layers is arranged in a plurality of columns configured to substantially maintain a spacing between at least two other layers of the plurality of layers upon a bending of the MEM switch structure.

A ninth embodiment represents a MEM switch controller for supporting a gray scale, wherein the switch controller includes a power supply modulator that is configured to supply a first level voltage or a second level voltage over a scan period, and wherein a switch contact is made during a lower voltage of the first and second level voltages.

A tenth embodiment represents a MEMS backplane that includes an A/C voltage source suitable for an electroluminescent display material; a first power supply for the electroluminescent display material; a second power supply for cycling a display or latching information for the display; and a contact arranged to maintain separation of the first and second power supplies.

An eleventh embodiment represents a MicroElectroMechanical System (MEMS) switch element that is optimized for a display or printer application. The MEMS switch element has a first mechanism for controlling the operation of the switch element and a second mechanism for maintaining the switch element in a closed position.

A twelfth embodiment represents an ElectroMechanical (EM) display backplane that includes a plurality of perforations in one or more of a plurality of structural elements of the EM backplane, wherein the plurality of perforations are configured to alter electromechanical properties of the EM backplane.

A thirteenth embodiment represents a method of making an EM display backplane. The method includes depositing a high dielectric constant (high-k) and/or a high polarizability (high-P) material.

A fourteenth embodiment represents a steering mechanism that includes an electrostatic switch and an occultating disk array, wherein the occultating disk array is independently translatable in a plurality of directions, and wherein the steering mechanism is configured to steer an image from a display without substantial degradation of a quality of the image.

A fifteenth embodiment represents an electromechanical display that includes a mask structure coupled to at least one of a plurality of layers of a MEM switch, wherein the mask structure is configured to provide improved off-axis contrast and on-axis contrast.

A sixteenth embodiment represents a mirror-based display pixel that includes a primary reflective surface and a secondary reflective surface configured to traverse from the primary reflective surface in an on state and to return to a position relatively close to the primary reflective surface in an off state.

A seventeenth embodiment represents a MEMS switch element that includes a plurality of polymers foil including a C layer foil that is coupled to a B layer in proximity to an A layer foil and also coupled to a D layer in proximity to an E layer wherein the C layer is not under tension.

An eighteenth embodiment includes an extra set of electrostatic plates on the E layer and on a Cb side of the C layer, and the C layer is slack such that electrostatic plates on both the A and the E layers are operable to pull the C layer out of contact with a complimentary layer.

A nineteenth embodiment includes a C layer disposed in an “S” shape within the cell confines.

### BRIEF DESCRIPTION OF THE DRAWINGS

FIG. 1 is a diagram illustrating a display that includes plural flexible MicroElectroMechanical (MEM) pinch-cells according to an embodiment of the present invention.

FIG. 2 is diagram illustrating a cross-section of a pinch-cell of FIG. 1.

FIG. 3 is a diagram illustrating the pinch-cell of FIG. 2 when activated.

FIG. 4 is a diagram illustrating an alternative embodiment of the pinch-cell of FIG. 2.

FIG. 5 is a diagram illustrating components positioned on a flexible membrane layer of the pinch-cell of FIG. 2.

FIG. 6 is a diagram illustrating components positioned on a base layer of the pinch-cell of FIG. 2.

FIG. 7 is a diagram illustrating a first exemplary layout of traces for an electrostatic cell according to an embodiment of the present invention.

FIG. 8 is a diagram illustrating an alternative pinch-cell according to a first illustrative embodiment of the present invention.

FIG. 9 is a diagram illustrating an alternative pinch-cell according to a second illustrative embodiment of the present invention.

FIG. 10 is a diagram illustrating an exemplary display backplane according to an embodiment of the present invention.

FIG. 11 is a diagram illustrating a voltage-versus-time graph over one column-scan cycle for cell constructed according to an embodiment of the present invention.

FIG. 12 is a diagram illustrating an exemplary Latch Power Supply (LPS) voltage-versus-time output for a cell constructed according to an embodiment of the present invention.

FIG. 13 is a diagram illustrating a mask layer and a display assembly employed to implement a cell according to an embodiment of the present invention.

FIG. 14 is a diagram illustrating a pixel, in an on or actuated state, constructed according to an embodiment of the present invention.

FIG. 15 is a diagram illustrating a cross-section of a first mirror-based display according to an embodiment of the present invention.

FIG. 16 is a diagram illustrating a cross-section of a second mirror-based display according to an embodiment of the present invention.

FIG. 17 is a diagram illustrating a cross-section of a Low-Tension Cell (LTC) according to an embodiment of the present invention.

FIG. 18 is a diagram illustrating a cross-section of an S-cell according to an embodiment of the present invention.

### DESCRIPTION OF EMBODIMENTS OF THE INVENTION

Various embodiments of the present invention relate to a micro-electromechanical switch, a low cost flat panel or electrophoretic display having a micro-electromechanical backplane and various other devices using or incorporating the micro-electromechanical switch.

For clarity, various well-known components, such as amplifiers, capacitors, resistors, dielectric coatings, and so on have been omitted from the figures. However, those skilled in the art with access to the present teachings will know which components to implement and how to implement them to meet the needs of a given application. Furthermore, various figures are not drawn to scale. Those skilled in the art may readily determine suitable component dimensions for a given application without undue experimentation.

For the purposes of the present discussion, a switch may be any device that can selectively divert, redirect, connect, or otherwise route a signal between points. Examples of switches include but are not limited to relays, multiplexers, demultiplexers, transistors, vacuum tubes, and so on.

A control line may be any conductor or other waveguide that carries one or more signals for controlling the operation of one or more devices or modules, such as software and/or hardware modules. A ground line may be any conductor or other waveguide that connects to or selectively connects to ground or approximately zero volts. A ground line may connect to ground through one or more circuit elements, including resistors, inductors, and so on.

A polymer material may be any material that substantially comprises plural repeated structural units or links, such as monomers. Examples of polymers include polyimide, polyester, various other plastics, and so on.

An elastic material or layer may be any material or layer that exhibits at least one elastic property in whole or in part. The exact degree of elasticity of a layer or material in the present embodiment is application specific and may be chosen by one skilled in the art to meet the needs of a given application without undue experimentation.

A flexible material may be any material that can bend or fold a desired amount without breaking. The degree to which a flexible material can bend depends on its degree of flexibility.

An electroluminescent material may include any material that emits light upon application of sufficient energy, such as electrical energy.

A wedge may be any narrowing between a first layer or surface and a second layer or surface.

A light-emitting unit may be any device that emits light when activated. Examples of light-emitting units include, but are not limited to, Light-Emitting Diodes (LEDs), phosphors, emissive polymers, light bulbs, and so on.

An electrode may be any electrical conductor. An illumination electrode may be any electrode employed to facilitate activating a light-emitting unit. An actuator electrode may be any electrical conductor employed to facilitate operation of an actuator.

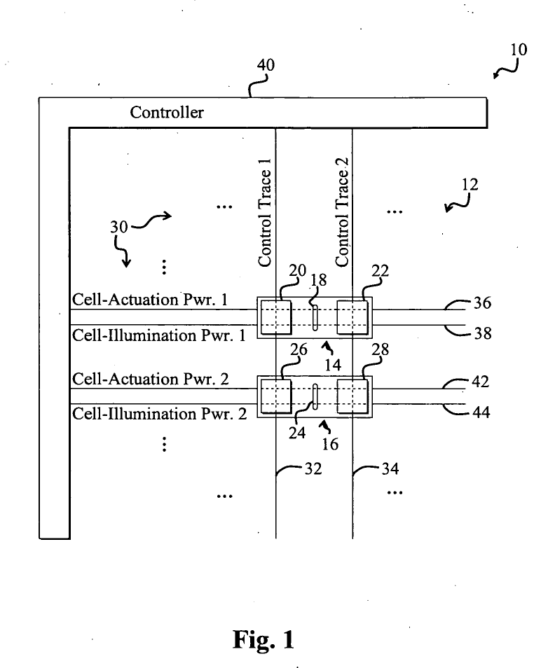

FIG. 1 is a diagram illustrating a flexible display 10, which includes an array of flexible MicroElectroMechanical (MEM) pinch-cells 12 according to an embodiment of the present invention. For illustrative purposes, a first cell 14 and a second cell 16 are shown. The first cell 14 includes a first protruding structure 18 that pinches the first cell 14, forming a first sub-cell 20 and a second sub-cell 22. Similarly, the second cell 16 includes a second protruding structure 24 that pinches the second cell 16, forming a third sub-cell 26 and a fourth sub-cell 28. The protruding structures 18, 24 indent top layers of the cells 14, 16, resulting in plural operational and structural advantages as discussed more fully below. The cells 14, 16 are called pinch-cells due to the pinching action of the protruding structures 18, 24. For the purposes of the present discussion, the sub-cells 20, 22, 26, 28 are also called cells.

In the present specific embodiment, various power and control traces (or “scan” traces) 30 are shown connected to the pinch-cells 14, 16 in an exemplary configuration. The first sub-cell 20 and the third sub-cell 26 are coupled to a first controllable ground line 32. Similarly, the second sub-cell 22 and the fourth sub-cell 28 are connected to a second controllable ground line 34. The controllable ground lines 32, 34 may act as column-select traces that facilitate enabling columns of cells in preparation for activation of desired cells in the selected column.

The first sub-cell 20 and the second sub-cell 22 share a first cell-actuation power line 36 and a first cell-illumination power line 38. Similarly, the third sub-cell 26 and the fourth sub-cell 28 share a second cell-actuation power line 42 and a second cell-illumination power line 44. A controller 40 is coupled to the power and ground traces 30, which act as control lines. The controller 40 selectively controls signals sent via the traces 30 to the cells 14, 16.

In operation, each sub-cell 20, 22, 26, 28 implements both a switch and a light-emitting unit, both of which are selectively grounded via the controllable ground lines 32, 34, as discussed more fully below. Before a given sub-cell is switched on, and the associated light-emitting unit is activated, the corresponding controllable ground line 32, 34 is grounded by the controller 40. For example, to activate the first sub-cell 20, the controller 40 grounds the first controllable ground line 32. Subsequently, the controller 40 applies an appropriate voltage to the first cell-actuation power line 36 to a MicroElectroMechanical (MEM) switch accompanying the first sub-cell 20, thereby connecting an accompanying light emitting unit between the first cell-illumination power line 38 and the first grounded controllable ground line 32. Subsequently, the controller 40 applies a voltage to the first cell-illumination power line 38 that is sufficient to turn on the light emitting unit accompanying the first sub-cell 20.

By strategically applying voltage to the cell-illumination power lines 38, 44 after the cell-illumination power lines 38, 44 are connected to grounded sub-cell light emitting units via accompanying MEM switches, electrical arching is reduced. This may improve the longevity of the sub-cells 20, 22, 26, 28.

Separating the cell-actuation power lines 36, 42 from the cell-illumination power lines 38, 44 may provide additional significant advantages, including enhanced control-over cell operation. For example, a given light-emitting unit, such as a phosphor element or an Organic Light-Emitting Diode (OLED) may require a different turn-on voltage than the corresponding switch, which is readily accommodated by including separate power lines for cell actuation and cell illumination functions.

While the present embodiment illustrates a particular configuration of power and ground traces, other configurations are possible. For example, the controllable ground lines 32, 34 may be replaced with different signal lines, such as lines that provide negative voltages or otherwise do not selectively provide zero volts. Furthermore, an additional set of lines may be employed so that various MEM switches and accompanying light-emitting units do not share common ground lines.

Other connection schemes for connecting an array of cells are discussed more fully in co-pending U.S. patent application Ser. No. 10/959,604, entitled MICRO-ELECTROMECHANICAL SWITCHING BACKPLANE, and assigned to the assignee of the present invention, the teachings of which are incorporated by reference herein. This above-identified U.S. Patent Application further discusses various materials, electrodes, and so on, which may be employed by those skilled in the art to facilitate readily implementing embodiments of the present invention without undue experimentation.

Various algorithms for implementing the controller 40 may be implemented in hardware and/or software by those skilled in the art with access to the present teachings without undue experimentation. Page: 11

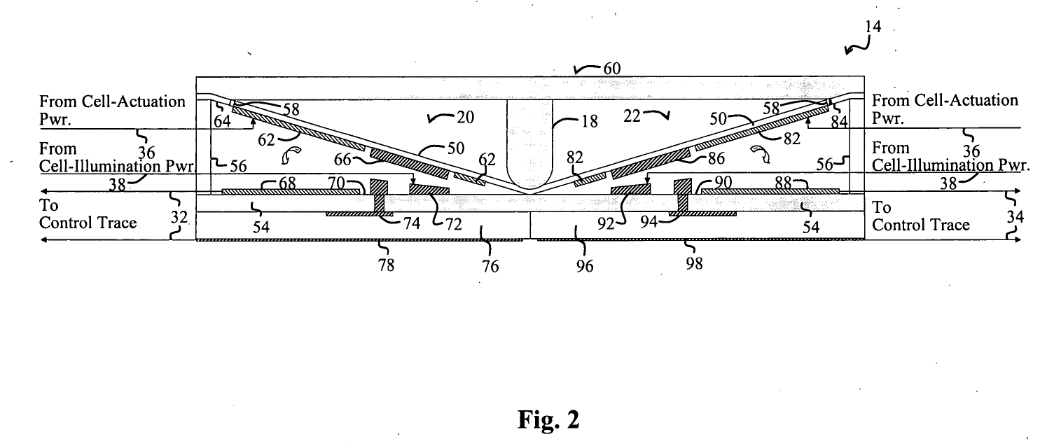

FIG. 2 is a diagram illustrating a cross-section of the first pinch-cell 14 of FIG. 1. The pinch-cell 14 includes a first elastic flexible layer 50 that is indented, stretched, or otherwise deflected downward via the protrusion 18. In the present specific embodiment, the protrusion 18 is sufficiently long to press the flexible layer 50 against a second layer 54 at the protrusion 18.

The protrusion 18 separates the pinch-cell 14 into the first sub-cell 20 and the second sub-cell 22. The first flexible layer 50 is separated from the second layer 54 via sidewalls 56, which act as a support structure that supports the pinch-cell 14 at a perimeter of the pinch-cell.

The protrusion 18 causes the first flexible layer 50 to be angled relative to the second layer 54 in the first sub-cell 20 and the second sub-cell 22, forming wedges therein. The wedges narrow at the location of the protrusion 18, while the wedges widen toward the perimeter sidewalls 56. Perforations are placed in layer 50 near the join point to sidewalls 56, which facilitate gas flow in and out of the sub-cells 20, 22 during actuation of the sub-cells 20, 22. The perforations 58 may improve the energy efficiency of the pinch-cell 14.

The protrusion 18 is integrated with or is otherwise coupled to a third layer 60, which is positioned on a side of the first flexible layer 50 that is opposite the second layer 54. The third layer 60 is supported by the sidewalls 56 and presses the first flexible layer 50 between ends of the sidewalls and the third layer 60. The sidewalls 56 are approximately perpendicular to the third layer 60 and the second layer 54.

The flexible layer 50 may be implemented via a thin polymer membrane. The membrane 50 may be made from various polymers, including Du Pont® polyimide, polyethylene terephthalate, polyethylene naphthalate, and other polymer alloys or elastic material.

The second layer 54 and the third layer 60 may also be implemented via flexible polymer materials. However, in the present specific embodiment, the second layer 54 and the third layer 60 are thicker than the first flexible layer 50, and consequently, less flexible. Exact flexibility characteristics and dimensions of each of the layers 50, 54, 60 are application specific.

The first sub-cell 20 and the second sub-cell 22 are similarly constructed and operated. The first sub-cell 20 includes a first actuator electrode 62, which is positioned on a first surface 64 of the flexible layer 50, facing the second layer 54. The first actuator electrode 62 substantially surrounds a first contact electrode 66, also called a terminal, or contact, which is positioned on the first surface 64 of the first flexible layer 50.

The first sub-cell 20 further includes a second actuator electrode 68 that is positioned on a second surface 70 of the second layer 54. The second actuator electrode 68 faces the first actuator electrode 62 positioned on the first flexible layer 50.

A second contact electrode 72 is positioned on the second surface 70 of the second layer 54 facing the first contact electrode 66 positioned on the first flexible layer 50. A third contact electrode 74 is coupled to the second layer 54 and extends from the second surface 70 of the second layer 54 facing the first contact electrode 66 to a first light-emitting unit 76. A first transparent electrode 78 is mounted on a surface of the light-emitting unit opposite the second layer 54. The third contact electrode 74 is electrically isolated from the second contact electrode 72 when the pinch-cell is not activated as shown in FIG. 2.

The second sub-cell 22 of the pinch-cell 14 includes various components and surfaces 82-98, which directly correspond, in construction and operation, to the components 62-78 of the first sub-cell 20.

In operation, with reference to FIGS. 1-2, the controller 40 connects the first controllable ground 32 to ground, thereby grounding both the (optionally) transparent electrode 78 and the second actuator electrode 68. Subsequently, the controller 40 applies a suitable voltage to the cell-actuation power line 36, which is coupled to the first actuator electrode 62 mounted on the first flexible surface 62. The application of voltage to the first actuator electrode 62 causes an electrical charge differential to build between the actuator electrodes 62, 68. This charge differential causes an attractive force sufficient to pull the first flexible layer 50 toward the second layer 54 and vice versa. In accordance with Coulomb's law, the attractive force between opposing charges on the first layer 50 and the second layer 54 is inversely proportional to the distance squared between the charges. The electrostatic forces between the first flexible layer 50 and the second layer 54 build until the first contact electrode 66 bridges the second contact electrode 72 and the third contact electrode 74, thereby electrically coupling the electrodes 72, 74.

After a predetermined settling time, the controller 40 of FIG. 1 supplies sufficient voltage, via the cell-illumination power line 38, to cause electrical current to pass from the third contact electrode 74 through the first light-emitting unit 76 to the first transparent electrode 78 to the grounded first controllable ground line 32. This causes the first light-emitting unit 76 to emit light. Similar processes may be employed to selectively activate the sub-cells 20, 22, 26, 28 of FIG. 1, which implement pixels, to create a desired image.

When current flowing between the contact electrodes 50, 72, 74, a charge differential between the first contact electrode 60 and the second contact electrode 72 and between the first contact electrode 66 and the third contact electrode 74 may cause sufficient electrostatic forces therebetween to latch the sub-cell 20 into an activated state. When the sub-cell 20 is latched, voltage applied to the actuator electrodes 62, 68 may be removed, thereby conserving power. In the present specific embodiment, voltage applied to the cell-illumination power lines 38 will be insufficient to actuate the sub-cells 20, 22, but will sufficient to hold the sub-cells 20, 22, i.e., switches 20, 22 in latched positions when the contacts 50, 72, 74 and 86, 90, 92, respectively, touch.

Use of the protrusion 18 brings portions of the first flexible layer 50 closer to the second layer 54, which increases electrostatic forces between the layers 50, 54 for a given charge differential. This enhanced attractive force, in addition shorter distances between contact 74, 72 on the second layer 54 and the first electrode contact 66 on the first flexible layer 50, may reduce cell switching times.

The enhanced attractive force and decreased contact spacing may further reduce flexibility requirements of the first flexible layer 50. Consequently, thicker, less flexible, more robust, more manageable, and often more cost-effective materials may be employed to build the pinch-cell 14.

Furthermore, use of the protrusion 18 may reduce the volume of gas existing in the wedge between the first flexible layer 50 and the second layer 54. Consequently, gas in the wedge that must evacuate out the holes 58 in the sidewalls 56 or otherwise be compressed, is less than would be required without the protrusion 18. In addition, less energy may be required to evacuate less gas from the sub-cell 20. Furthermore, less time may be required to evacuate or compress the gas. This results in energy savings and faster switching times.

Furthermore, certain manufacturing equipment may have size constraints, such as wall-spacing requirements. Ordinarily, such constraints may result in relatively large cells. Use of the protrusion 18 may overcome some size constraints, resulting in substantially smaller cells 20, 22 that are half the size of other cells.

Furthermore, protrusion 18 inhibits the pinch-cell 14 from collapsing when bent, which could compromise the function of the pinch-cell 14. Accordingly, the protrusion 18 and the angle between the first flexible layer 50 and the second layer 54 may enhance the ability of the sub-cells 20, 33 to withstand bending. Consequently, since the pinch-cell 14 is now more resistant to bending, more flexible materials may be used for the second layer 54 and the first flexible layer 50. Hence, use of the protrusion 18 may further reduce pinch-cell design constraints, such as materials requirements, and may improve manufacturing margins accordingly.

While a specific electrode orientation is shown in the embodiment of FIG. 2. Other configurations, including different electrode shapes and spacings may be employed without departing from the scope of the present invention. For example, in an alternative embodiment, the second contact electrode 72 may be omitted, and the cell-illumination power 38 may be routed on the flexible layer 50 instead of the second layer 54, thereby replacing the first electrode contact 66.

While substantially square or rectangular pinch-cells are discussed herein, the exact shape and dimensions of a pinch-cell constructed according to embodiments of the present of the present invention are application specific. For example, certain applications may call for hexagonal pinch-cells with different aspect ratios.

Various manufacturing techniques may be employed by those skilled in the art to implement embodiments of the present invention without undue experimentation. For example, an ink-jet printing process may be employed to construct the sidewalls 56. A laser may be employed to create the perforations 58. The various electrodes, such as the electrodes 62, 666, 68, 72, 74, may be printed on polymer sheets corresponding to the various layers 50, 54 via conductive ink or via well-known vapor deposition techniques.

Various well-known low-temperature semiconductor fabrication and MEMS-manufacturing techniques may also be employed to implement various features, such as the protrusion 18. MEMS-manufacturing techniques may include various masking techniques, such as using photoresist, ultraviolet light to selectively denature the photoresist in masked desired patterns, and chemical-etching substance to remove the denatured photoresist. Advanced MEMS etching techniques, such as techniques involving use of xenon difluoride gas may also be employed to implement various features of embodiments of the present invention.

Electrodes may be implemented via various conductive materials, including but not limited to copper, aluminum, chromium, silver, gold, nickel, tin, zinc, and so on. The (optionally) transparent electrodes 78, 98 may be implemented via indium-tin oxide or other transparent conductors. The exact choice of conductive material is application specific. Appropriate materials may be selected by those skilled to implement embodiments of the present invention without undue experimentation.

Preferably, materials employed to implement various electrical contacts, such as the actuator electrodes 62, 68, 82, 88, are equivalently flexible to the underlying layers 50, 54. For example, the modulus of elasticity of the first actuator electrode 62 preferably matches to modulus of elasticity of the first flexible layer 50 to minimize stresses occurring at the interface between the first flexible layer 50 and the first actuator electrode 62.

The light-emitting units 76, 96 may be implemented via ElectroLuminescent (EL) material, gallium-arsenide LEDs, electrochromic, or electrophoretic, compartments containing phosphor, plasma cells, and so on.

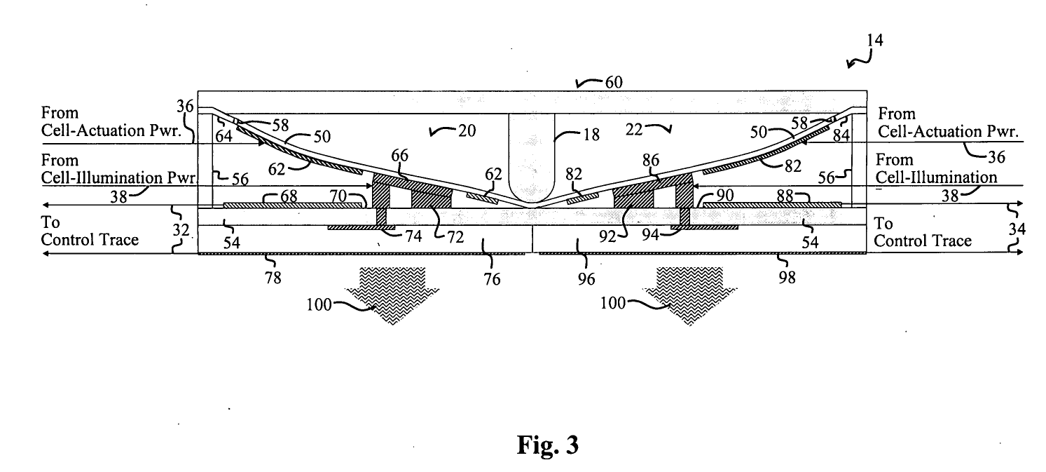

FIG. 3 is a diagram illustrating the pinch-cell 14 of FIG. 2 when activated. In FIG. 2, both the first sub-cell 20 and the second sub-cell 22 are switched on in preparation for activation of the accompanying light-emitting units 76, 96.

When the sub-cells 20, 22 are activated, the first flexible layer 50 is deflected downward by electrostatic forces between actuator electrodes 62, 68 and 82, 88 between the first flexible layer 50 and the second layer 54. The first layer 50 is sufficiently deflected to cause the first contact electrodes 66, 86, to bridge the second and third contact electrodes 72, 74 and 92, 94 on the second layer 54.

In the present specific embodiment, the various contact electrodes 72, 74, 92, 94 on the second layer 54 are strategically shaped to facilitate maximum electrical contact with the first contact electrodes 66, 86 on the first flexible layer 50 when the sub-cells 20, 22 are actuated.

After the connections between the contact electrodes 66, 72, 74 and 86, 92, 94 have stabilized, and the controller 40 of FIG. 1 applies a sufficient voltage via the cell-illumination power line 38, light 100 is emitted from the light-emitting units 76, 96.

When voltage is removed from the actuator electrodes 62, 68, 82, 88 and the contact electrodes 72, 74, 92, 94, the first flexible layer 50 snaps back to its original position as shown in FIG. 2 due to the elastic properties of the first flexible layer 50.

The actuator electrodes 62, 68, 82, 88 may be coated with an electrically insulating material, such as plastic, to prevent electrical contact between the actuator electrodes as discussed more fully below.

The exact dimensions of the various electrodes of the pinch-cell 14 are application-specific. For example, the contact electrodes 72, 74, 92, 94, i.e., terminals, may be made large enough to produce sufficient electrostatic attraction between the first flexible layer 50 and the second layer 54 to actuate the flexible layer 50 without departing from the scope of the present invention. In this configuration, the actuator electrodes 62, 68, 82, 88 may be omitted. This configuration may be suitable for applications where arching and durability are not a concern.

Furthermore, the sub-cells 20, 22 may be implemented on a stand-alone basis, such that the sub-cells 20, 22 are not part of a larger pinch-cell 14 or array of pinch-cells. In such applications, a sub-cell, such as the sub-cell 20 may be implemented in a box or other compartment that can accommodate an angled flexible layer with appropriate electrodes positioned thereon.

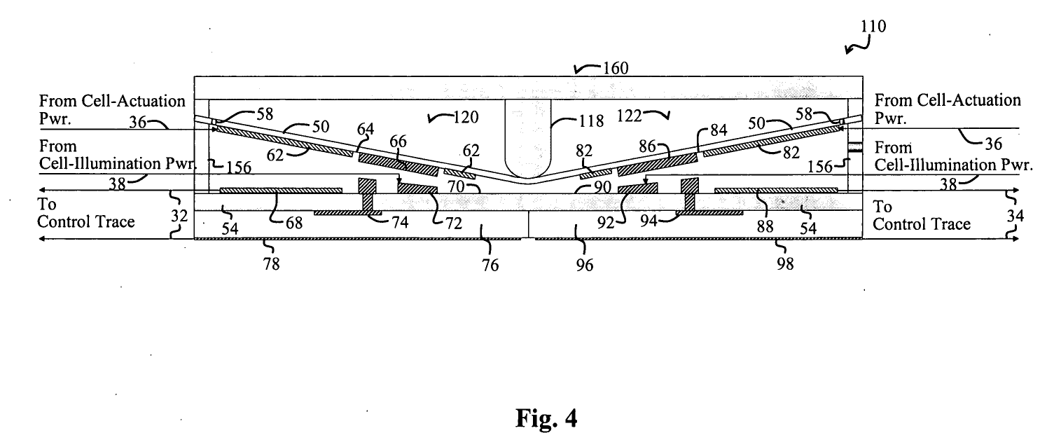

FIG. 4 is a diagram illustrating an alternative embodiment 110 of the pinch-cell 14 of FIG. 2. The construction and operation of the pinch-cell 110 of FIG. 4 are similar to the construction and operation of the pinch-cell 14 of FIGS. 2-3 with some exceptions.

In particular, the protrusion 18 of FIGS. 2-3 is replaced with a relatively shorter protrusion 118 extending from a modified third layer 160 in FIG. 4. Unlike the protrusion 18 of FIGS. 2-3, the shorter protrusion 118 does not fully indent the flexible layer 50 and does not press the flexible layer 50 against the second layer 54.

Furthermore, unlike the pinch-cell 14 of FIGS. 2-3, the first flexible layer 50 shown in FIG. 4 is secured directly to perimeter sidewalls 156 partway between the modified third layer 160 and the second layer 54, rather than between ends of the sidewalls 156 and the modified third layer 160. The dimensions of the first flexible layer 50 may be adjusted to accommodate the different positioning along the sidewalls 156 and the shorter protrusion 118.

The modifications to the attachment locations of the first flexible layer 50, and use of the shorter protrusion 188 are exemplary and result in a first modified sub-cell 120 and a second modified sub-cell 122.

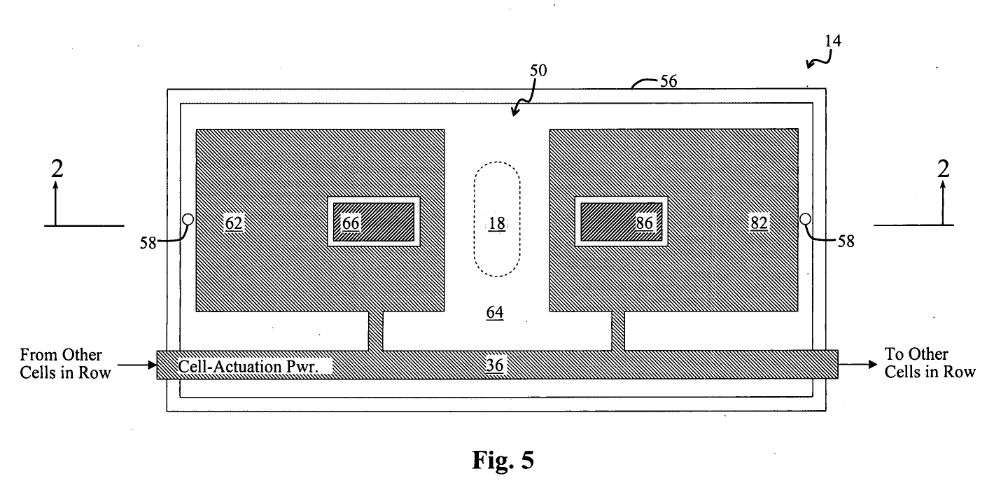

FIG. 5 is a diagram illustrating components disposed on the first flexible layer 50 of the pinch-cells of FIGS. 2-3. With reference to FIGS. 1, 2, 5, the cell-actuation power line 36 is employed by the controller 40 to supply voltage to the first actuator electrode 62 and the second actuator electrode 82, which are positioned on opposing sides of the protrusion 18. The first contact electrodes 66, 86 are substantially surrounded by the actuator electrodes 62, 82. The various electrodes 66, 86, 62, 82 are positioned on the first flexible layer 50 within the perimeter sidewalls 56 of the pinch-cell 14

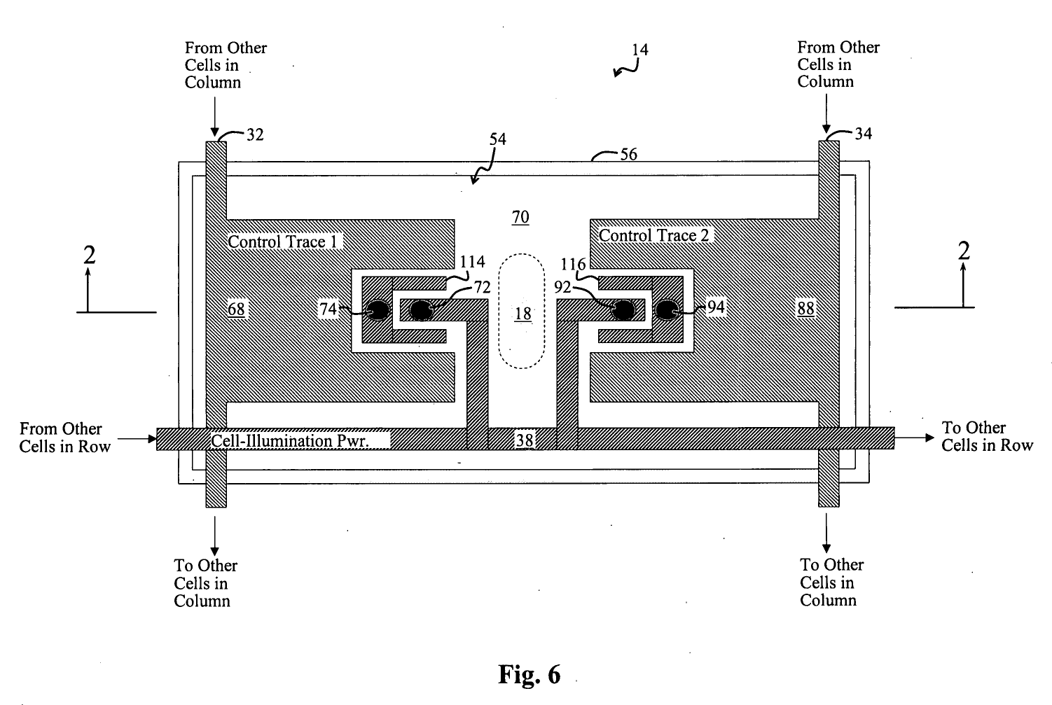

FIG. 6 is a diagram illustrating exemplary components positioned on the second layer 54 of the pinch-cell 14 of FIGS. 2-3. The second actuator electrodes 68, 88 are positioned on opposing sides of the protrusion 18 and are selectively grounded via the controllable ground lines 32, 34, respectively, which are controlled by the controller 40 of FIG. 1. The second actuator electrodes 68, 88 may be connected to different types of control lines other than controllable grounds without departing from the scope of the present invention. Furthermore, the second actuator electrodes 68, 88 may be connected to row traces rather than column traces.

The second contact electrodes 72, 92 are selectively energized by the cell-illumination power line 38 of FIGS. 1-3. The third contact electrodes 74, 94 are shown including additional latching conductor material 114, 116, respectively. The additional material 114, 116 may facilitate latching the sub-cells 20, 22 in actuated positions via electrostatic forces between the additional material 114, 116 and the first contact electrodes 66, 86 of the first flexible layer 50 of FIGS. 2-3, 5. As previously mentioned, trace routing and component layout can be different in other embodiments.

The various shapes and relative sizes of the electrodes, the protrusion 18, and other components are application specific. Those skilled in the art may employ different shapes and sizes for various components of various embodiments disclosed herein without departing from the scope of the present invention.

While various embodiments of FIGS. 1-6 are discussed with respect to pinch-cells 14, 114 that are adapted for use with a display, such as a flat-panel display or flexible electronic paper, other uses are possible. For example, various cells disclosed herein may be resized or otherwise adapted to virtually any application that demands a switching function that may be implemented via electrostatic forces and one or more flexible membranes.

Furthermore, while certain embodiments are discussed with respect to employing electrostatic forces to actuate a switch with a flexible membrane or layer, other forces are possible. For example, the first flexible layer 50 may be implemented via piezoelectric materials that move in response to application of a desired current or voltage, without departing from the scope of the present invention.

The following discussion addresses various related devices and embodiments of the present invention that are suitable for use with MEMS switches discussed herein.

### Switch and Display with Built-in Enunciator Function

Displays that incorporate touch-sensitive switch elements are well known in the art. These may be somewhat complex devices that are usually limited to the size of the display component. Because of the cost of large area displays, the applicability of the combined display and switch for use in large area readouts may be limited. A mechanism and method to dramatically increase the size and decrease the cost of display and switch assemblies is needed.

One aspect of embodiments of the present invention is the creation of a display and touch sensitive switch structure that can be manufactured from plastic foils and an appropriate display media.

Another aspect of embodiments of the present invention is the use of micro electromechanical (MEM) technology to create the switch matrix assembly.

Another aspect of embodiments of the present invention is the use of roll-to-roll manufacturing technology for the manufacture of the display and switch assembly.

Another aspect of embodiments of the present invention is the use of a switch backplane assembly, such as a Flexible Array Switch (FASwitch™), a trademark of Rolltronics Corporation, with an electrophoretic display media, such as made by E-Ink Corporation.

A FASwitch™ structure uses a switch array technology, based upon the creation of MEMS devices on flexible foils of plastic and other materials. The manufacturing process is most optimally that of roll-to-roll processing, such as used in the flexible printed circuit industry. The FASwitch™ switch has been seen to be appropriate for use as a backplane assembly for displays made with various display media.

Such a switch array backplane was laminated with electrophoretic materials make it possible to create an enunciator switch. That is, it is possible to create a touch sensitive switch that simultaneously would change the visual state of the electrophoretic material. Each pixel of the display became its own touch sensitive switch element and display element.

In this implementation of a switch backplane and electrophoretic display media, an XY array decoder may be incorporated in addition to the typically display driver circuitry. Extra contacts can be incorporated into the basic switch cell to detect the press event. When a press event, not generated by the display driver itself is detected, the system powers the cell so that the electrophoretic display media changes state. In this way the pixel has now indicated that that pixel has been touched. The XY array decoder can then determine the location of the pixel that has been depressed.

As will be discussed further herein, the operation of the switch and display assembly can include the flexing of a membrane switch to make contact as one of two mechanisms for the switch to contact. The other way for the switch to contact is by means of a deflection of the display media, which is transferred to the switch backplane, causing the A layer of the switch to contact the C layer, the opposite of what typically happens to the switch element. When the switch makes contact, the electrostatic attraction of the A and C layers is created, and the switch element is latched into an ON state. If the XY decoder determines that the pixel was already in a latched condition, the pixel is instructed to release the switch and return the E-Ink material to a reference (OFF) state.

### Secure Data (SD) Memory Devices in Signage Applications

Advertising signage is commonly used in a variety of locations, such as restaurants, food stores, and others. This signage may be scaled to fit in the interior of the locations and is often on the order of 30 cm×100 cm in size. The last major upgrade of this interior signage was the neon glass tube sign. As Flat Panel Displays (FPD) have gained acceptance and have enjoyed technical improvements that allow their use in interior signage, an interesting problem emerged. The FPD requires a controller to create the images. This controller itself requires a memory of the sort of images that are to be displayed. The current generation of FPD signs have limited memory size and therefore a finite and small number of images that can be shown. Worse, the images are typically not subject to being upgraded as time goes on.

One aspect of embodiments of the present invention is the incorporation of a secure removable memory component into an FPD sign.

Another aspect of embodiments of the present invention is the software necessary to create and encrypt the images that are to be shown in the sign.

A typical sign requires an area for image creation. It may also incorporate display driver circuits, a display controller, and a secure removable memory component. The industry standard Secure Data (SD) memory card may be used for this application, since it already incorporates the data encryption and is of a convenient device size.

A separate computer system, suitable for programming the SD memory cards, may also be required in some applications and this computer system has software that can be used to create and encrypt the data specifically for the display.

In a sign according to embodiments of the present invention, along with the usual structure of display media, illumination system, perimeter molding (often quite complex in structure and appearance) and interior drive electronics, there can be a socket for a Secure Digital (SD) memory card. The size of the card can be so small that it will be obvious to those skilled in the art that no major change in the structure of the sign may be required to incorporate this added functionality. Further, the location of the sign can be secreted into the structure so that tampering is made less likely.

The SD card can be exchanged as updated images are created. It can also be exchanged to accommodate special announcements, such as price change information or greetings to specific customers.

Incorporated into the SD card can be a time stamp, important in some applications where it is decided that a specific image would not be appropriately displayed after a certain date. Alternately, the same time stamp may allow seasonal signs to reappear if the sign is left in place for more than one year without update.

The SD card can be thought of as an image library and its associated image display instructions. Among the parameters that can be programmed into the SD card are the speed with which the images are exchanged, the time of image display, the periodicity over time that a given image is displayed, and even the wear out of a given image after it has been shown a certain number of times.

The SD card can also track the use of the sign, the number of hours the sign is on in a give period, the number of times that the retailer would manually call for a new image (a function that is easily installed into the upgraded SD-based display), and report this information to the advertiser when the SD card is removed for updating.

A standard electrical/physical bus structure is typical for the SD card, and it is straightforward to create an interface to the interior image controller function in the sign.

A sign can be manufactured, but no image information is incorporated into the assembly. When the use of the sign is established, an SD card programmed for that location may be created and inserted into the sign. When the sign is turned on, the content specific advertisements are loaded into the controller and are shown on the FPD.

### Improvements to a MEM Switch Array for Display and Other Applications Optimized for Low Voltage and High Current Display Devices

A novel micro electromechanical (MEM) switch array can be constructed from plastic foils and metallized coatings of the foils. The general utility of the switch array (e.g., using FASwitch™) has been revealed for display materials as diverse as electrophoretic, liquid crystal, electrochromic, light emitting diode, plasma emission, and others.

It is herein revealed that several improvements can be incorporated into the basic design of the switch array and its individual cell structure to better optimize them for the use of display materials that require low voltages and high currents. Representative of such display materials would be light emitting diodes (LED).

A rearrangement of the power bus structure to lower the impedance of the power lines used to directly power the LEDs and an elaboration of the switch contact structure to simultaneously lower the on-state impedance and make a more reliable switch assembly is proposed.

In one aspect of embodiments of the present invention, the arrangement of the power bus structure of the switch array is altered to reduce the impedance for low voltage and high current applications.

Another aspect of embodiments of the present invention is the creation of a structured contact array to lower on-state impedance and improve device reliability.

Another aspect of embodiments of the present invention is the creation of a power bus structure that can dissipate heat from the primary display media without unduly heating the underlying electrostatic switch cell.

Another aspect of embodiments of the present invention is the creation of multiple via structures between the power bus structure to the electrostatic switch structure, thereby reducing the on-state impedance of the entire array.

Embodiments of the present invention can include two complimentary parts. The first part deals with the reduction in the power bus structure electrical impedance by means of a novel layout of power bus and via structure. The second part deals with improvements in the electrostatic switch contact structure to better address the low impedance requirements of the high current display materials (LED, etc.).

A fundamental improvement in the switch structure came about with the realization that the main display power bus structure does not have to be incorporated within the confines of the electrostatic cell structure, but rather can be incorporated onto the outside face of the cell structure. Moving the display power bus structure onto the outside of the electrostatic switch structure effects several immediate improvements: (i) the electrical state of the power bus structure does not in any way alter the electrostatic field of the switch, making for an electrically more robust design of the electrostatic switch array; (ii) the display power bus can be expanded to encompass nearly the entire area of the display, thereby dramatically lowering the bus impedance; (iii) the display power bus can be significantly increased in thickness without altering the details of the design of the electrostatic switch cells, again lowering the bus impedance; (iv) the display power bus can function, at least to a limited extent, as a heat spreader and this is important for dissipative display media like LEDs; (v) the thickness of the display power bus can beneficially alter the stiffness and robustness of the entire display so as to protect the electrostatic switch elements from environmental effects by the intersection of the relatively strong display power bus structure; and (vi) the large area of the display power bus can make it possible to derive benefit from the incorporation of a multiplicity of vias through the structure to make connections to the electrostatic switch cells. Other improvements associated with the use of a robust metal foil in front of a relatively fragile film are easily seen.

According to another aspect of embodiments, an advantageous layout pattern of electrical contacts is included with the design for an electrostatic switch cell, herein referred to a pinch-cell. This contact structure can use an array of contacts, half on the movable element of the switch cell and half on the fixed structure of the switch cell. The use of the structure may allow many electrically conductive contact points to make or break contact simultaneously. The increase in the number of the contacts and the fact that they can all be made to make or break at the same time means that they can be made to share current flows in the cell. The ability to share current flows significantly increases the lifetime and reliability of the switch contacts, without otherwise complicating the cell design.

In contrast to the electrostatic switch cell array, which may have row and column traces disposed on adjacent sides of two foils, the Low Impedance Bus (LIB) can be constructed using power, display element power, and ground traces that run parallel to each other on the same substrate surface. The LIB traces can be made to run parallel to or perpendicular to the column traces of the electrostatic cell. The reference to the column driver of the electrostatic switch cell is arbitrarily selected as the basis for discussions of the orientation of the parts of the switch array. The column drive trace is defined to run in the Y direction, while the row drive trace is defined to run in the X direction.

In one embodiment, three (optionally two) LIB traces are assumed to be approximately equal width and thickness, but this is an arbitrary decision and one which can be modified to accommodate such physical exigencies as a specific connection to an LED which more readily conducts heat from the LED device to the LIB trace. In such a case, it might be desirable to increase the width of the LIB trace that makes the connection to the hot lead of the LED.

The disposition of the LIB traces can be influenced by the physical configuration of the LED device used in the display. It is possible for an LED device to have a connection on one side and its second connection its opposite side. In this configuration, the two LIB traces need only accommodate a single polarity of power and display element power, with a latticework of ground connections on the opposite face to complete the circuit.

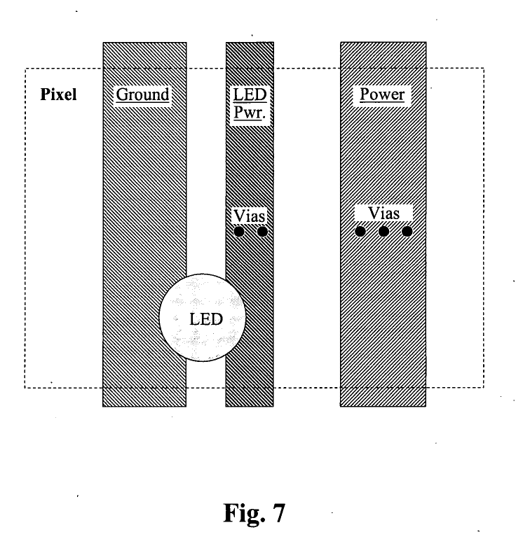

An arrangement of LIB traces on the aft side of the display is shown in FIG. 7. In this case, there are three traces running substantially in parallel. One trace may be the scan power, one trace may be the display element power, and the third can be a ground connection, for example.

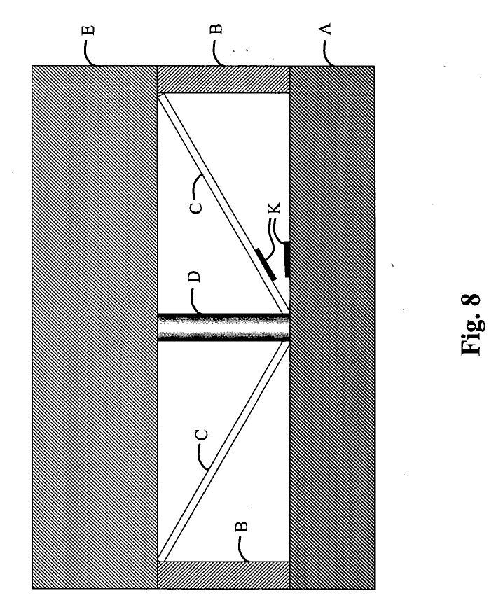

There can be arrays of via structures for each electrostatic cell, one array for scan power and one array of vias for display element power connections, for example. The exact number and configuration of vias is determined by the electrical requirements of the LED devices chosen for the display. An exemplary configuration is shown in FIG. 8.

In some implementations, the power and/or ground bus structure may not be required on layer A for all LED designs. It is possible that the power bus structure may be retained on the A layer, but that the ground bus may be associated with another structure, not using layer A at all.

Some versions of the electrostatic cell design may dispose their multiplicity of switch contacts in a radially-symmetric pattern. For reasons associated with the dynamic behavior of a rapidly moving membrane structure, the assumption that all of the contacts will be a constant distance apart and will contact together all at the same time cannot be taken for granted. The discovery that a fast moving membrane structure may assume one of several configurations, defined by the well known Bessel function, places a significant limitation on the speed at which the membrane can work successfully.

The pinch-cell design according to embodiments is also subject to some resonant behavior at high frequencies, but note that these resonant behaviors dispose all of the contacts to the same spacing and not different spacings. So, while not immune to the Bessel function effects, the switch contact bank can be expected to all contact at the same time. Realize that this problem of simultaneous contact is usually a high frequency phenomenon, and for many display applications it will not be a significant limitation.

Each bridge structure can bridge two via contacts together. One of the via contacts connects to the power bus and the other via contact connects to the display device. It is completely acceptable that a continuous bridge structure is created across all of the pairs of via contacts. This has the advantageous effect of creating useful redundancy in the switch array.

External connections of the power bus and ground bus are by preference all made along one edge of the display. This edge is arbitrarily chosen to match the engineering design of the display as it is integrated into the device that is using the display. It is clear that power could be provided on one edge and ground could be connected to the opposite edge, if the particular design implementation so requires.

It also may be possible for the power and ground bus structure to be at an angle other than 0 or 90 degrees with regard the connections to the electrostatic switch. All angles would not serve, but at certain angles the power and ground buses would overlap cells in the display in a useful pattern.

In operation, row and column driver circuits of the switch element may be operated at the normal voltages and duty cycles. A latching mechanism can alternatively be included into the design.

The A layer, which is seen to have two (at least) via contacts, now has a pattern on its front face of two power and one ground bus structures. FIG. 7 shows a representative layout of traces. The C layer has a bridging structure and a contact pair (at least one pair and ether a single or a multiplicity of bridge structures). When the electrostatic cell is activated, the layer C bridging structure is brought into contact with the layer A via pair structure, and electricity from the power bus is conducted though the first via, through the first via contacts, through the bridge structure, through the second via contact, through the second via structure, and to the LED device.

### Improvements to a MEM Switch Array to Reduce the Impact of Contact Sticking

In some MEM switch array implementations, contact sticking has sometimes been encountered. Contact sticking has to do with the inability of the closed switch to return to an open state when power is removed from the switch cell. This failure to return to a neutral state has many possible causes, such as: (i) contact arcing; (ii) van der Waals attraction of the foils in proximity; (iii) mechanical interlocking of non-smooth surfaces; (iv) electrical behavior on the part of the dielectric materials; and/or (v) surface contamination of the foil materials with compounds that alter the surface energy of the of the foils and increase their attraction to each other. One or all of these causes may be active in a given switch cell, and a universal solution to all of these issues is needed.

In one aspect of embodiments of the present invention, an electrically conductive plate structure can be incorporated into the switch array.

Another aspect of embodiments of the present invention includes using the electrically conductive plate structure that can also function as a gettering material for contamination of the cell structure.

In switch implementations as described herein, the laminated foils are identified as layers A through E (with optional layers beyond E understood to exist as needed, but not usually elaborated on since they are typically mechanical mounting structures with great application variability.) According to embodiments, a conductive layer can be incorporated onto the interior cell face of layer E. This conductive plate can effect a strong attraction to the flexible foil C. This attraction can pull a struck foil C out of contact with the foil of layer A. The electrostatic attraction of layer C by the conductive plate on layer E, henceforth called the complimentary trace, will provide the added electrostatic power to fix the sticking problems, as discussed above.

Another use of the complimentary trace is to compensate for manufacturing variations of the cell array or environmental excursions from optimal operation parameters. In this way, the complimentary trace can be biased so as to put a predictable offset into the switch behavior in a direction that can be easily manipulated to aid the operation of the switch cell.

The complimentary trace is an un-patterned or patterned conductive material deposited onto the interior face of layer E. This (these) conductive trace(s) can have an area that overlaps the conductive traces on layer C. By powering the complimentary trace, a significant electrostatic attraction can be generated on layer C.

An electrical connection to an outside driver circuit may be required to activate the complimentary trace. Such an electrical driver circuit must be coordinated with the row and column driver circuits of the array.

In operation, at a specified interval in the array timing cycle corresponding to the cell reset time, the electrical potential of the complimentary trace may be raised sufficiently high to create useful attraction between the complimentary trace and the row trace (typically) on layer C. This attraction can enhance the mechanical spring relaxation force and pulls the flexible membrane C back into its neutral position. The complimentary trace potential may then returned to a zero potential or to a bias potential that effects an optimal adjustment in the parameters of the switch cell on the basis of temperature or manufacturing variabilities.

### Improvements to a MEM Backplane

In some MEM switch array implementations, array devices can include thin foils of polymer and other materials to create switch arrays. Such switch arrays have a variety of uses including: optical display backplane, printers, and memory devices.

A significant engineering constraint on such devices is the modest electrostatic attraction available and the relatively large plate gap spacing. With a gap spacing that is consistent with many practical applications, with a foil material with an adequately low elastic modulus, and with an electrostatic voltage that was compatible with typical display materials, the cell design had smaller than desirable manufacturing margins. The manufacturability of such a cell can be improved.

Herein is described a cell design innovation that dramatically widens the window of manufacturability. It also has several desirable traits with regard the electrostatic requirements of the design, and the switching speed of the design. Further, materials of higher elastic modulus, and therefore easier handling in manufacture, can be used. Further, enhancement to the flexibility of the display backplane is possible.

According to one aspect of embodiments of the present invention, a column or similar structure that causes the flexible layer to come into intimate or near-intimate contact to the fixed electrode layer at all times can be inserted.

Another aspect of embodiments of the present invention includes the reduction in the displaced gas volume of the newly designed cell, reducing the power needed to move the gas.

Another aspect of embodiments of the present invention is the reduction in the displaced gas volume of the newly designed cell, reducing the time needed to change the state of the switch.

Another aspect of embodiments of the present invention is the ability to increase the elastic modulus of the flexible membrane, thereby improving manufacturability.

Another aspect of embodiments of the present invention is the realization that if a single cell element of the previous technology had a minimum size constraint, the new design allows the same area to contain two active cells.

Another aspect of embodiments of the present invention is the creation of a cell structure, which is significantly less constrained by the relative flatness of the substrate.

One cell design is shown in cross-section form in FIG. 8. The layers of the structure are identified as layers A through E. These structures are identified as layers, because of the original assumptions about the manufacturing process. The mechanism of the cell's operation is the electrostatic deflection of layer C to bring it into contact with layer A. When the contact is made, a switch contact K is closed between the layers and electric power is made available to the display material and for other purposes.

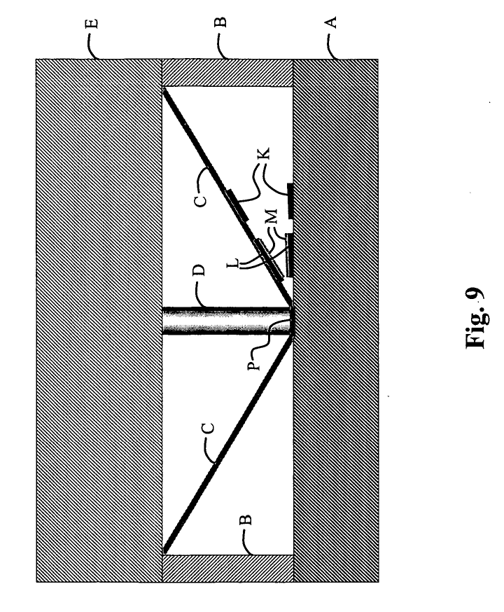

Another cell design according to embodiments of the present invention is shown in FIG. 9. A 5-layer structure can be retained, but the layout of elements in layers C and D have been significantly altered. According to embodiments, the layer D cell edge connections has been reduced or entirely eliminated and a new layer D center column (or wall) structure has been created. This layer D column can depress the C layer at point P until the layer C material is in close proximity or intimate contact with layer A. Because of the existence of an insulating layer M on (by preference) layer A, there may be no electrical contact of the Row and Column driver plates L of layers C and A respectively. The spacing of the row and column driver plates can very small at the contact point and therefore the electrostatic attraction between these plates is very high. The electrical contacts may be displaced to a location away from the column contact point to a location some distance away from the layer D contact point. The exact electrical contact location is subject to engineering optimization on the basis of contact area, planarity, pull in voltage requirement and other factors, for example.

As shown in FIG. 9, Layer A can be the interface to the display material by means of electrostatic and/or direct electrical contact. Layer A can contain electrostatic plates, identified as the Column Driver plates. It also may, but is not required to, contain a plate called the Latch Plate, which can be used to make the backplane a bistatic switch. Layer C can be deflected into contact with layer A when the film has no electrostatic force on it. In addition, the Bridge contact defined on layer C may be offset away from the mechanical contact point. Layer D has a perimeter contact area that may be reduced in height or even entirely eliminated. Further, a column (or wall) that is used to define the contact point (or line) of the C layer to the A layer can be added to the structure of the D layer.

While layer C may require perforations in it in order to allow for the displacement of the trapped air in the C/A side of the cell during operation, the absolute volume of air that needs to be displaced for a full switch function can be significantly reduced according to embodiments. Such a reduction in volume of displaced air has two immediate beneficial effects: (i) the energy needed to displace the air can be reduced by half; and (ii) the speed with which the air can be displaced may be increased, which means the switch can switch faster for a given drive voltage.

According to embodiments, no alteration of external connections may be required. The scan voltage for the row and column drivers, and the display/latch voltage will need to be defined, as a part of the selection of flexible materials, cell size, and spacing between layer A and layer C at the perimeter of the pixel frame.

In operation, voltages may be presented to the column driver plate (also called a scan plate) and the row driver plate (also called a scan plate). Because of the proximity of layer A to layer C, at the mechanical contact point P, the substantial electrostatic attraction pulls the foils C and A together at their narrowest point of contact. As the voltage on the scan plates is increased, a greater and greater area of contact between the foils is created. Eventually, a large portion of the foils A and C are in contact, held that way by electrostatic forces. During the process by which the foils are brought into contact, electrical switch contacts are also brought into contact and can be used to power the display and latch the cell into a fixed on-state.

By bringing the layers C and A into substantial proximity or intimate contact, the force available for electrostatic attraction has been increased. Taking into consideration the effect of the dielectric (arbitrarily defined for a 0.5 um thickness of dielectric), a typical cell of ˜1 cm extent could have an electrostatic force of 250× that of the undeflected layer C in the area of proximity to the layer D column. Instead of having to generate enough electrostatic force to deform the C layer from its rest position (25 um distant from the A layer in a representative exemplar), the electrostatic force can begin to deflect layer C from a spacing of <0.5 um. Since layer C is already in close contact, the electrostatic forces are great and the ability of the cell to switch reliability has been significantly improved.

### Use of Gettering Materials to Improve the Lifetime and Performance of MEM Switch Array Devices

In some switch array implementations, a major limitation in the lifetime of the array may be the contamination of the switching contacts. This contamination was perceived to be coming from environmental gases that leak into the seal array elements, and also from organic chemicals which are exuded from the polymer substrates that are the basis for the array itself.

The presence of Oxygen, Carbon Dioxide, Water Vapor and the volatile organic components were expected to create high resistance pathways on the contact faces of the electrical contacts of the design. The metal oxides, hydroxides, and the polymerized organic films could easily be seen to accelerate the failure of the switching elements. A selection of materials and structure were discovered which will substantially reduce the concentration of the damaging components.

In one aspect of embodiments of the present invention, a reactive gettering film can be incorporated into the structure of the switch array.

In another aspect of embodiments of the present invention, the placement of the gettering structure can be such that normal operation of the array is not substantially altered.

In another aspect of embodiments of the present invention, the use of specific gettering materials can include active metal getters such as Calcium and/or Lithium.

In another aspect of embodiments of the present invention, specific gettering materials that are substantially transparent can be used, such as deposited Lithium Aluminum Hydride.

At least 5 operative layers can be incorporated into a switch design according to embodiments. The electrical switching elements can be disposed on layers A, B, and C. The gas balance elements can include layers D and E. According to embodiments of the present invention, a metal gettering film can be added onto the inside face of layer E.

A layer of an active metal gettering material can be deposited onto the inside face of layer E, within the gas volume of the sealed switch cell. This material may be deposited by vacuum evaporation or vacuum sputtering, for example. Metal thicknesses of from a few tenths of microns to several tens of microns would be optimal for this application. Thicknesses outside this range may be used as necessary or desirable. Depending upon the exact structures of layers D and E, the material may also be found deposited on portions of structures of layer D, but this will do no harm in the context of this invention and will in fact increase the useful area of deposited gettering material.

Such switch array structure alterations may be made substantially independent of any external connection and may not adversely effect any changes in the sequence of assembly, or the subsequent reliability of the completed array, for example.

In operation, the gettering material can react with reactive gases that leak into the cell structure or were in the cell structure at the time of the cell assembly. Since there are holes for gas passage in the C layer, the entire volume of gas within the cell is exposed to the gettering material, and so is cleansed of impurities. In some switch cell operation, there is a distinct gas pumping action, so as the cell changes state the gases are positively, and with some turbulence, mixed and exchanged between the front of the cell, where switching takes place, and the back side of the cell, which functions as a gas ballast. This can ensure that the reactive gettering chemical will have good access to the entire gas volume.

One result of the incorporation of reactive gettering compounds into the E structure is that the appearance of reactive gases in the cell structure, from gas molecules that have diffused into the back of the E layer and through the plastic material of the E layer structure is reduced to essentially zero. This has an advantageous effect on the quality of the cell structure and can be expected to improve the cell reliability.

### Film Stack for Radiation Detection

By the use of plastic materials for construction and roll-to-roll manufacturing methods, the cost and utility of the switch arrays have been significantly improved over conventional approaches, including silicon thin film transistors (TFT) on glass substrates and silicon transistors on silicon substrates.

In order to simplify the manufacturing methods even further, a layering of stiff and flexible substrate films can be included. Such layers can be used to implement a sensor, as will be discussed in more detail below.

One aspect of embodiments of the present invention is the creation of a multi-layer film stack of plastic and other substrates, which can be used as a wide area sensor array.

Another aspect of embodiments of the present invention is that such film stacks can be used for detection of actinic radiation, including x-ray and gamma rays.

Another aspect of embodiments of the present invention is that such a film stack can be used for the detection of ridge structures in handprints.

Another aspect of embodiments of the present invention is that such a film stack can be used for the detection of longer wavelength electromagnetic radiation, thereby allowing imaging of intensity distribution of radiation fields.

According to embodiments, thin foil implementations of a switch array include the flexible membrane or cantilever structures were spaced apart from other substrates. The interaction of the separated foils, flexible and stiff respectively, can create the changes necessary to affect the necessary electromechanical effects. According to embodiments of the present invention, the flexible foil C begins in intimate contact with one substrate A and another substrate E effects a separation of the A and C layers. When layers A and C are in contact, there are electrical contacts, which can register the contact. When the layers A and C are separated, the same contacts can indicate the separation. When the voltage source creating the electrostatic attraction of the C and E layer is turned off, the connections of the C and E layer are put into a high impedance state (high-Z state) and the charge on the electrodes on layers C and E may not be allowed to drain off through the connections to the outside power source.

With the layers C and E electrically isolated from the outside world, it is still possible for their electrostatic charge to bleed away in several ways and for the flexible layer C to relax-and-recontact layer A. Four mechanisms for charge leakage are appreciated: (i) bulk leakage of charge through the solid structures joining layers C and E; (ii) surface leakage across the surfaces connecting layers C and E; (iii) leakage directly from plate to plate with conduction through the gas itself; and (iv) leakage from charged particles generated by natural processes in the environment which deposit charged species in the gas space between plates.

The high surface area to edge perimeter structures are most optimal for these devices and therefore square or round electrostatic cells plane views are typically best in some implementations. Straightforward calculations from well known electrical resistivity tables suggests that bulk resistivity of the typical materials used in the construction of these switch arrays will be several orders of magnitude lower than other leakage mechanisms. Minus unusual amounts of surface contaminants, such as alkali ions or unusual amounts of moisture, similar information on surface leakage mechanisms suggests that the surface leakage does not constitute a major leakage path for these structures although it may be one or two orders of magnitude larger than the bulk leakage. Minus other leakage mechanisms, it would be the dominant leakage mechanism. The intrinsic ionization coefficient for most useful gases is very low, and at least as low as the surface leakage for the cell. The electrical field between the electrostatic plates of layers C and E does not create a significant space charge that would cause field emission nor does it have an opportunity to create a ion cascade because of the small distances involved (<50 um).

With other mechanisms well understood and seen to be of very small consequence, the creation of charged particles in the gas phase by means of ionizing mechanisms can be considered. These mechanisms can include direct ionization of the gas by the passage of ionizing photons, such as x-ray or gamma radiation passing through the volume of the cell. Another, more efficient, source of ionizing particles in the gas phase can take place by means of secondary cascades. An ionizing photon of radiation can be absorbed onto a solid surface and then a cascade of charged particles of lower net energy but greater numbers can be emitted from the surface. These charged particles drift into the charge space between the electrostatic plates and effect the neutralization of the -electric field between the electrostatic plates. When enough of the electrostatic charge is neutralized, layer C can contact layer A and the contacts thereon are connected and able to be scanned for state. By means of this mechanism, it is possible by noting the time that it takes for a given switch to contact, to back calculate the deposited radiation dose on the area of the cell. With an array of switch cells, a fully developed image of the deposited dose of radiation over the area can be seen. Applications can include x-ray detector panels for radiographic analysis, for example.

Components of embodiments of this invention are labeled A through E (optionally F and G). Layer A is rigid and contains an array of electrical contacts. Layer B is a spacer between layers A and C, but may be optional in a specific design. Layer C contains orthogonal contacts to those on layer A. In addition there are large areas of electrostatic plates on C. Layer D is a spacer layer separating layers C and E. Layer E contains complimentary areas of electrostatic plates to that of layer C. Layer E may be, but does not have to be, a rigid structure. If layer E is not rigid, then a structure F and G may be created to protect layer E from physical damage in handing and environmental contamination. Layer F can be a spacer layer analogous to layer D and layer G is rigid attachment structure.

The external connections of embodiments of this invention include connections on layers C and E to effect the separation of layers A and C, and an orthogonal set of connections to the contacts of layers A and C. An external scan mechanism may be required to interpret the pattern of contacts over time.

In operation, an attractive potential may be established between layers C and E. A timer can be started and the array may be scanned for the state of the contacts between layers A and C. As cells make contact between layers A and C, a time to gray scale conversion is made and the information may be stored in a computer memory or a suitable display device.

A material that converts incoming actinic photons into charge cascades between layers C and E can be inserted into the structure so that the maximum use is made of the incoming radiation. It should be noted that materials that may be part of the typical design of this family of film-based designs may work adequately for this task. Aluminum films of 40-60 nm may prove substantially adequate for the scintillation material. If not, there are a large number of well known materials that are specialized for use as scintillation materials.

### Improvements to a Micromechanical Backplane Design for Display Applications Having Enhanced Flexibility

In a membrane switch (MEM backplane) designs a substrate flatness of less than 2 um may be required for the smallest implementations of this technology. What is needed is a way to use of this technology in displays that are curved.

In one aspect of embodiments of the present invention, columns can be inserted into the buffer structure D, as will be discussed in more detail below.

Another aspect of embodiments of the present invention is the possible elimination of the buffer structure D so that the display is comprised of parts A through C and E; but without buffer structure D.

The MEM type display backplane as discussed herein can include 5 layers, A through E. The first three layers may be substantially unchanged according to embodiments of the present invention, but layer D may have a series of columns, perhaps several to many per pixel area, inserted. These columns may be attached to layer E, for example. These columns may or may not contact layer C during normal operation of the display. When the display is bent back, the columns can contact layer C and support it at a constant distance from layer A.

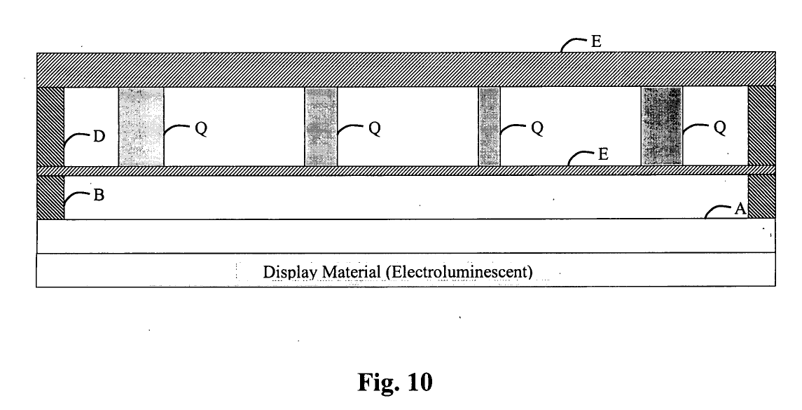

Referring to FIG. 10, in the fabrication of the display backplane, an elaboration of the layer D is included. Instead of having strictly perimeter attachments of layer D, designed to adhere layer C to layer D, several column structures Q are incorporated into layer D. Such columns Q may or may not touch layer C during its normal operation. The columns Q can be fabricated at the same time and with the same technology as the current elements of layer D and so do not constitute added complexity in the manufacturing process.

When the display is bent backward, the columns Q maintain the spacing between layers C and A, so the electrical properties of the display backplane are not significantly altered as it is being deformed.

An alternative to the insertion of the column structures Q in layer D is the complete elimination of layer D. This has the result of layer C being in direct contact with layer E and the same stabilization of layer C relative to layer A is effected. The elimination of the gas buffer layer created by layer D does have the effect of reducing the rate at which gas can flow from the front of layer C to the back of layer C and there may be an associated reduction in the switch rate. Note that in different embodiments display material may be placed on either side of layer A.

In one embodiment, all associated external connections to the array can remain unchanged. Further, normal function of the MEM backplane is expected, except as noted herein. The design may also need minor modification to accommodate the reduction in gas buffer volume because of the presence of the columns.

### Improvements in the Mechanism for Production of Gray Scale Images Using a MEMS-Based Active Matrix Display Backplane Structure

In a MEMS-based active matrix gray scale display backplane the making and breaking the conductive electrical contact while there is a significant voltage potential across the contacts may cause a problem. Electrical contacts of this sort are well known to be robust to voltages up to about 10 VDC, but limitations in lifetime can be observed if the contacts are made and/or broken at potentials much above that level. It is to address such limitations that an improvement in the Latch Power Supply (LPS) is herein described.

One aspect of embodiments of the present invention is a modification of the LPS so as to produce an output waveform that avoids the excessive erosion of contacts when they are used at high voltages.

Another aspect of embodiments of the present invention is that the LPS is still able to effectively latch the MEMS-based switch.

Another aspect of embodiments of the present invention is that by a sequence of stepwise volt increases in the LPS, the dynamic range of the gray scale can be increased.

If the LPS is raised to a specific voltage, such as above 25 VDC, the row and column drivers can pull in the switch elements (which powers the latch trace) and the latch power is maintained at >25 VDC until the scan cycle is reset. One limitation is that electrical contact is made when the contacts are at too high a voltage potential for long contact lifetime. By modulating the LPS voltage between approximately 10 VDC and 30 VDC during the period of the scan cycle and coordinating the timing of the closure of the MEMS-based switch with that of the LPS, the switch contacts can be exposed to lower instantaneous voltages during their make and break cycle and so have their lifetime significantly extended.

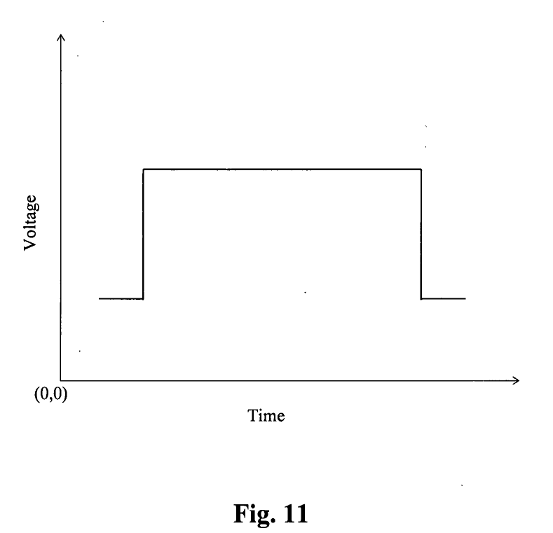

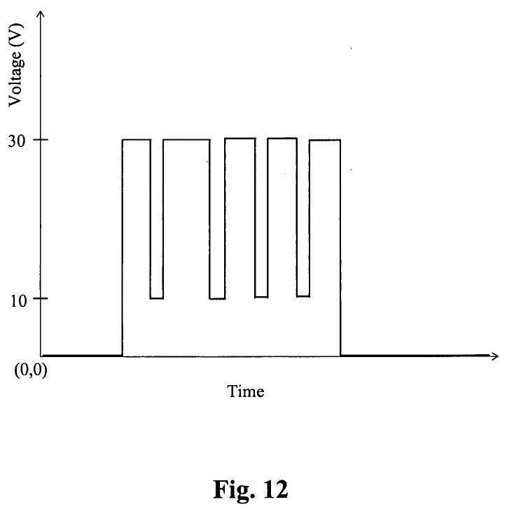

Most active matrix MEMS-based structures can be used without substantial modification in accordance with embodiments of the present invention and can benefit from the change in the LPS and associated revised timing of the MEMS-based switch latching. Referring now to FIG. 11, a voltage versus time diagram over the period of one column scan cycle shows a representative example of the previous LPS Output to the latch power trace and so on to the latch contacts. Referring now to FIG. 12, the LPS output is shown in a similar voltage versus time scan, but with the simplest implementation of the added features. In FIG. 12, the maximum voltage of the output is substantially the same as in FIG. 11. The periodic reduction in voltage to ˜10 VDC takes place for only a short period of the total column scan period. Because the row and column drive circuits are active during the entire column scan period, there is no likelihood that the switch element will unlatch during these brief intervals when the latch voltage has dropped. It can be seen that the optimal time for switch contact is during the time that the latch voltage has been reduced to ˜10 VDC. This means that switching can take place at one of several times during the entire envelop of the LPS output column scan period. In this way a display element can be turned on for a selected period of the total column scan period and the longer the display element is turned on, the more intense its photo response will be. In this way, a gray scale is produced based upon time multiplexing of the column scan timing.

To compensate for non-linearity in the photo response of the display material, at least two changes in the LPS output can be used. In one alternative embodiment, the interval between notches can be altered, to change the amount of power that is transferred to the display material. In another alternative embodiment, the voltage of the LPS output does not have to remain constant for the entire column scan period, but might be altered to compensate for the display material characteristics.

According to embodiments of the present invention, the LPS output characteristics can be controlled. The LPS may be under computer control, and so is subject to programmed alteration of its Output characteristics. Synchronization of the LPS to the row and column drive circuitry may be under the same computer control and is coordinated with the LPS performance, for example.

### MEMS Display Backplane with High Voltage A/C Display Technologies

In some MEMS backplane design technology, the accommodation of a display material selection that requires an A/C voltage source for operation (e.g., electroluminescent display materials) may be required. Also, unsatisfactory switch lifetimes may result if the switching voltages much exceed 30 volts. Electroluminescent display materials require 50-100 volts A/C to operate. In order to address these limitations, device layout and timing of power pulses can be modified in accordance with embodiments of the present invention.

In one aspect of embodiments of the present invention, the major power for the display material can be routed to the display material independently of the power that cycles the display or latches the information of the display. This may be accomplished by the addition of an extra contact to the basic backplane layout of previous patent applications. Applications can include electroluminescent materials, and plasma display materials, for example.

Another aspect of embodiments of the present invention includes the coordination of the timing of the A/C voltage to the display material through a new contact such that at the time that the contact is being made or broken in the display backplane, the instantaneous voltage of the A/C supply is below the threshold of damage to the contact. This is posited to be an instantaneous voltage with an absolute magnitude of less than 30 volts.

Another aspect of embodiments of the present invention is the coordination of the timing of the A/C voltage waveform such that the backplane contact make or break timing can also effect a change in the gray scale output of the display.

Another aspect of embodiments of the present invention is the realization that the A/C voltage waveform has two periods of a single voltage cycle that can be used to make or break the contacts.

Another aspect of embodiments of the present invention is the realization that the frequency of the A/C voltage waveform may be optimized to better interface the critical timing of the MEMS switch to the display material.

Another aspect of embodiments of the present invention is the realization that the shape of the A/C voltage waveform can be altered in ways that maximize the interval acceptable for MEMS switching while still delivering the same power to the display material.

Another aspect of embodiments of the present invention is the realization that multiple voltage cycles may occur while the backplane contact is made, and that the output of the display may be modulated (for gray scale or color variations) by the selection of how many voltage waves are allowed to flow to the display material.

The addition of an extra, electrically isolated, contact can allow the power delivered to a display material to leave unaltered the electrostatic field of the latching trace of the MEMS switch. This improvement can allow MEMS backplane variants to continue to operate with a display material that flows significant current during operation (e.g., EL, or Plasma technologies).

The use of electroluminescent display materials alters the voltage requirements placed upon the contacts of the MEMS backplane. The increased voltages (50-100 VAC) and the fact that they are based upon an alternating current, rather than the direct current of other implementations, creates a requirement to carefully time the presentation of the voltage to the contacts of the MEMS switch during switch cycling. The device switching must be carefully timed so that the contacts are not damaged when the contacts are made or broken.

The switch layout can include a mechanism to deflect the flexible element of the switch and a contact that is so powered as to create a significant latching attraction when the switch is fully deflected. In addition to the contact(s) that may be required for device latching (which is the basis for the memory function of this display backplane as well as the basis for the successful creation of a gray-scale display), an extra electrically isolated contact, herein referred to as the second contact is inserted. This second contact makes and breaks at the same time as the latching contact, but is not electrically connected to the circuitry of the latching power supply. The second contact is connected to a power source that is separate and optimized to power the display material.

If a particular switch layout was topographically resistant to the incorporation of the second contact while retaining the same number of conductive and insulating layers, another layout method may be used. To resolve the topography problems that may arise with the incorporation of the second contact, the addition of an extra insulation and conduction layer may be needed. By preference these added layers would be incorporated onto the A layer, which is the more rigid layer of the structure. Incorporation of the added layers into the C layer, the flexible layer of the structure, may be less desirable, but is also possible. The layout of the flexible layer and the exact structure chosen (e.g., membrane structure versus cantilever structure) will determine if the addition of layers to the flexible portions of the switch structure is acceptable.

With the incorporation of the second contact, a further set of constraints can be considered to successfully interface the MEMS backplane to an electroluminescent (EL) display material. Specifically, the high A/C voltage requirements of an EL material means that the second contact, which would be powering the EL material, would be subject to voltages which are unlikely to allow long device lifetime. If the electrical contact is made at an arbitrary point in the A/C cycle, the voltage at the second contact could easily exceed the voltage potential for damage to the contacts as they make or break. The timing of the second contact make and break may not be arbitrary, but rather may take place only at times when the impressed A/C voltage from the display material power supply is less than the voltage that will cause damage to the second contact.

The identification of the time during the A/C cycle when the absolute voltage will be low enough that a second contact make or break will not damage the contacts is one aspect of embodiments of this invention. An A/C voltage is characterized by a frequency, a phase angle, a peak voltage, and a waveform. Because contacts are much more robust to impressed voltage and current after the contact is firmly made, a contact that would be terminally damaged by arcing at a given voltage and current upon make or break could easily survive to a long useful lifetime if those voltage and current peaks were avoided during the make or break process.

A fundamental realization in the use of A/C voltages with the MEMS backplane design is that the scan rate of the display should be coordinated with the A/C frequency. The frequency of the A/C voltage may need to be raised or lowered depending on the switching frequency range available to the MEMS switch element so that the proper coordination is obtained. There are two windows of time during a normal A/C cycle when the MEMS switch can make or break, and they are at or around the period when the voltage goes through 0 VAC. Clearly there is a critical phase angle consideration in when the MEMS switch element is activated and then, after a short interval of time, the contact can make or break. The switch element must be activated before the zero crossing of the A/C power supply so that at the time that the switch contacts arrive at their final make or break position, the voltage is within survivable range for the contacts.

The waveform of the A/C voltage is important because it is possible to alter the shape of the waveform to make it easier and safer for device operation. A waveform that has a high slope through the zero crossing is likely to be less forgiving of the critical timing of the MEMS switches. A waveform that is symmetrical around its peak voltage may also be less desirable than an unsymmetrical waveform that allows the MEMS switch more time to make before the full voltage and current flow are impressed.

An extra A/C power trace and second contacts can be included in MEMS switch backplane designs. Such an extra A/C power trace may be located on the A layer of the display backplane in which case a bridge contact pair can be incorporated onto the C layer of the backplane to route the power back to the A layer. Alternatively, the extra A/C power trace can be incorporated into the C layer in which case only a single extra contact is needed to feed power to the A layer.

When the MEMS switch is activated, the second contact connects the A/C power supply to the display material. The timing of the MEMS switch make or break cycle may be coordinated with the zero crossing of the A/C waveform so that the switch contact is not exposed to high voltages or currents during the time of contact make or break.

Gray-scale and color variation may be implemented by altering the number of A/C cycles over which a given MEMS switch element is kept in contact. Also, with the use of black and white displays and/or displays which only require a limited number of colors, the latching technology that creates a memory function in the backplane is available.

### MEMS-Based Active Matrix Technology for Display and Printer Technologies

MEMS-based active matrix technology for use in display and printer technology may be based upon the electrostatic attraction of a movable element to a substantially fixed base. Accordingly, such attraction may make an electrical connection that could power the display material and also, under some design circumstances, latch the display information so that the display does not need continuous rescanning of the display to maintain its information.

In one aspect of embodiments of the present invention, mechanisms other than electrostatic attraction can be used to effect the pull-in of the flexible element of the MEMS device to the fixed element of the MEMS device.

Another aspect of embodiments of the present invention includes the identification of differential thermal expansion as a mechanism that can affect the pull-in of the flexible element of the MEMS device.

Another aspect of embodiments of the present invention is the identification of the piezoelectric effect as a mechanism that can effect the pull-in of the flexible element of the MEMS device.

Another aspect of embodiments of the present invention includes the identification of electromagnetic attraction as a mechanism that can affect the pull-in of the flexible element of the MEMS device.

Another aspect of embodiments of the present invention is the identification of electrostatic repulsion as a mechanism that can effect the pull-in of the flexible element of the MEMS device.

Another aspect of embodiments of the present invention includes the identification of ion electric structural changes as a mechanism that can effect the pull-in of the flexible element of the MEMS device.

Another aspect of embodiments of the present invention includes the possibility that more than one of the above named mechanisms, including electrostatic attraction, can be combined in a single MEMS device structure to create a MEMS device that works more efficiently or with improved engineering properties.

Embodiments of the present invention can include two major aspects: (i) the use of mechanisms other than only electrostatic attraction to implement the pull-in of the MEMS device; and (ii) the use of two or more of these mechanisms to create designs for MEMS devices for display and printer applications that are improvements over the already disclosed mechanisms.

The use of physical principles other than electrostatic attraction for this application, as described above, can allow many engineering advantages. Electrostatic attraction may influence the display materials (e.g., electrophoretic display materials) in ways inconsistent with the successful application of these display materials. The substitution of another mechanism for MEMS operation may entirely sidestep these problems, making a more easy to design backplane design with better operation margins relative to voltage, timing, and current requirements.

The use of other mechanisms for MEMS switch pull-in and latching can alter the switch time-response of the backplane or the abruptness of the switch transition. The new mechanisms for operation may allow smaller switching elements in the MEMS device.

The use of other mechanisms for MEMS switch pull-in and latching can significantly alter the power consumption of the switch element. A switch pull-in mechanism that consumes significant current (e.g., differential thermal expansion used to create a bi-metal structure), but which uses electrostatic attraction to latch the switch, may have significant size advantages over an all electrostatic switch design. Coupled with a more compact MEMS switch design can be the possibility that the switch may consume less total power because of a possible increase in the response speed of the switch element.

The realization that a multitude of switch element principles can be combined to improve the engineering design of the switch pull-in and the switch latching mechanisms in accordance with embodiments of the present invention.

As one example, a differential thermal expansion bi-metal switch element can be combined with a small electrostatic latch area to create a smaller and more powerful MEMS switching design than is possible with electrostatic attraction for both the switch pull-in and the switch latching structures. This reduction in size can be a significant improvement in many implementations. The reduction in size of the switch element can mean that the switch element can be placed within the active area of the display material and still function correctly. This ability to incorporate the smaller switch element into the same volume as the display material means that the overall structure of the display can be simplified and the reliability of the display can be improved by the reduction in the number of elements that need to be sealed against environmental contaminants.

The basic connections to the outside of the display need not be significantly altered other that of the same display implemented using an all-electrostatic design. Depending on the selection of the display material, a particular combination of physical principles incorporated into the switching element may prove to be simpler to design. As an example, a display material that consumes significant current during the time that it is selected may lend itself to a switch design that consumes current to affect the pull-in. At the same time, any latching function of such a display may benefit from the use of an electrostatic latching mechanism, in order to minimize the power consumption of the display backplane active matrix while the display image is latched and unchanging.

The selection of the physical principles to be used in a given MEMS switch element design can be optimized for a display application. The primary issues to be appreciated involve the power generated by a given physical principle selection and the characteristics of its application. As an example, an electrostatic element has modest force for pull-in, but no net power draw after the element is caused to pull-in. A heated bimetallic structure can have a significant pull-in force, but will continue to consume power for as long as the switch is required to be held in. A piezoelectric element is expected to have useful power, but an especially fast response speed, balanced against leakages that exceed those of an electrostatic element. For a give display material, these properties may be of greater or lesser importance.

### Use of Selective Perforations on Backplane Structures to Enhance Mechanical and Electrical Properties of an Electromechanical Backplane

The incorporation of perforations into the structures of backplane components can beneficially alter such backplane properties as electrostatic sensitivity, resonance frequency, rate of change of sensitivity above the resonance frequency, oscillating mass, panel stiffness and others.

Several of the basic mechanical and electronic properties of the electromechanical display backplane (EM backplane) are constrained by factors, such as the relationship of stiffness of the flexible portion of the backplane (level C) to the amount of metallization on that panel. The ability to alter basic electromechanical properties, such as elasticity of the flexible panel independent of metal thickness or quantity of trapped gas in the switch structure is desirable.

The ability to alter in a beneficial way the electromechanical properties of the EM Backplane is effected by the incorporation of perforations in the structural elements of the backplane (e.g., levels A, B, and/or C). These perforations can be used to lower the mass of the oscillating element C. They can be used to alter the electrostatic sensitivity of the switch cell by reducing the pressurization of the cell as the flexible element on C is drawn toward element A.

Perforations on level C can also alter and reduce the mechanical stiffness of level C. This is desirable because the stiffness would otherwise be simply dominated by the stiffness of the metallic film that is deposited on the polymer substrate. Since the thickness of the metal film is determined by both the electrical conductivity needed and the abrasion resistance of the film, the ability to afford another degree of design freedom to the designer is important. Further, depending on the stiffness of the metal layer, such design freedom may be crucial to the successful engineering of the EM Backplane.

The size and placement of the perforations in the backplane levels can have several unexpected benefits for the design. A flexible display element, working at frequencies approaching the resonance frequency of the switch cell, may be subject to a phenomenon called breakup (where it is no longer correct to view the flexible element as a single structure resonating at a single frequency, but rather as a surface that is supporting several frequency modes), which is a well known phenomenon in loudspeaker design. The flexible surface is seen to be resonating at several frequencies at once, both at the primary frequency and at acoustic multiples of the primary frequency. The incorporation of perforations into the switch cell structure can alter the frequency and susceptibility to breakup of the flexible level.

The creation of perforations in the primary structure of the EM Backplane can be effected by one of several techniques and a selected technique will depend upon the specific level of the EM Backplane that is to be perforated.

Level A, the stiff portion of the EM Backplane, although this is not necessarily a requirement of the design, is thick enough (10-100 um) that dry etching, or even wet etching of a perforation may be problematic. Not impossible, but it is likely that the use of optical drilling (laser drilling) or some mechanical process would be most efficient.

The creation of perforations in level B is relatively straightforward, since this level can be perforated simply by photolithographic masking of the desired area. The perforations would be in the XY plane of the display and not, typically in the Z direction (through) the EM Backplane.

Perforations into level C are possible by many different mechanisms because of the intrinsic thinness of the film (1-20 um). Wet etching, dry etching, and laser etching would be perfectly acceptable. The resolution of these patterned perforations would not be difficult to effect using any of these technologies.

If perforations into either level A or C are made before the film is metallized, the metallization will attempt to coat the sidewalls of the perforation. The coating of the side walls with a seed layer of metal can be the basis for subsequent electroplating of a thicker metal coating into perforations and the possibility of the creation of through holes onto the back side of the level. Electrically conductive through holes in the levels of the EM Backplane can completely alter and enhance the applicability of the EM Backplane to all sorts of display materials and technologies, including but not limited to LCD, electrochromic and electrophoretic displays, for example.

### Use of High Dielectric Constant and/or Highly Polarizable Materials to Enhance the Performance of Electromechanical Backplanes for Display and Other Applications

The use of high dielectric constant (high-k) materials or dielectric materials with high polarizability can make a significant improvement in the operations of the electromechanical backplane. Further, incorporation of these materials can take place with no major change in the manufacturing process for the backplanes.

In the construction of the electromechanical backplane (EM backplane) previously described, an added deposition of a high-k material can take place at one of several locations. Specifically, the high-k material can be deposited: (i) on the soon to be metallized side of sheet A before the deposition of the metallic layer(s); (ii) on top of the metallic layers on sheet A either before or after these metallic layers are patterned; or (iii) the high-k material can be coated on sheet A on the side opposite that of the metallized layer. In each example, a significant increase in the capacitance of the pixel cell is accomplished, and therefore, a significant improvement in the ability of the pixel to retain visual information with fewer refresh cycles per second (minute, hour).

The use of high-k, high polarizability (high-P) materials is also possible, and can make an improvement to display applications, for example. A high-P material is well known to accept a significant amount of electrical charge in a capacitor structure and to retain a large fraction of that charge even after the capacitor is momentarily shorted to ostensibly remove all of that charge. A high-P material has undergone electrical changes that do not allow all of the accumulated charge to be quickly discharged. In this case there is a rebound in the electric field around the capacitor structure after a relatively brief shorting of the capacitor plates.

The utility of this property is seen in the process by which the backplane completes a column scan and prepares to select the next column of a display array. In a normal thin-film transistor (TFT) display, a transistor isolates a small capacitor structure, and this structure maintains some level of voltage on the display element after pixel deselect. In the case of the backplane, at the termination of the latch cycle, which does not have to last only for the period of the column select, the latch trace is brought to ground and then allowed to float electrically. With the inclusion of a high-P material into the latch trace structure, the latch plate will quickly float back up to a significant potential and because the latch plate is not connected to the scan array through a transistor, which can leak significant charge, will maintain the latch plate at a bias potential much higher than ground (probably as high as the potential before the latch trace was grounded). Further, the high-P material will lose this charge only very slowly, because the substrates have an extremely low leakage rate. Depending on the substrate material of sheet A, the leakage could be 6-8 orders of magnitude less than that of the transistor in the conventional TFT backplane.

In one example construction, sheet A may have a deposition of a high-k material directly onto the top surface. Surface treatments of A to improve adhesion and for other reasons may also be needed in some implementations. Deposition processes for high-k materials are idiosyncratic to the specific material, but can include CVD, PECVD, sputter deposition, reactive sputter deposition, high vacuum evaporation, and direct application of pastes or slurries by roll coating. The top surface of the deposited high-k material may require a separate treatment to increase adhesion to the subsequent metal layer deposition, and may require special handling during manufacture, such as low humidity containment, or specific gas ambients, in order to insure stable high-k properties.

### Steerable Optical Display to Selectively Control Display Field of View via Electromechanical Activation

Currently, typical optical display technologies have limited fields of view, with degradations of contrast and brightness as an observer exceeds these limits. The phenomenon can be so severe that the display is not visible at all at significant angles. There are times when an off-axis viewing angle is unavoidable, and currently there are no mechanisms to correct the problems so created. However, it may also be undesirable for a display to have a wide field of view (e.g., when one does not want an adjacent passenger on an airplane to view a personal laptop computer) and again there is no effective mechanism to create such a display.

On aspect of embodiments of the present invention is the creation of an electrostatic switch and lens assembly that can be used to steer the image from a display, without degradation of image quality.

Another aspect of embodiments of the present invention is the creation of a micro-lens array.

Another aspect of embodiments of the present invention is the creation of an occultating disk array.

Another aspect of embodiments of the present invention is the creation of an occultating disk array that is independently translatable in the X, Y, and Z direction.

Another aspect of embodiments of the present invention is the ability to regulate the field of view of a display.

Another aspect of embodiments of the present invention is the ability to regulate the contrast of the display.

Another aspect of embodiments of the present invention is the ability to regulate the brightness of this display.

A mechanism for the creation of a display device using a lens assembly and an array of occultating disks can involve either the lens array holder (layer A) or the occultating disk array holder (layer C) being made to translate in the XY plane of the device. This can define the optical axis as the Z axis of the device, so the display can alter its optical axis direction. Altering the optical axis means that the display is now optimized for a different angle of viewing. Depending upon the particular application and device to be made, this change in the optical axis of the display may be a factory one-time adjustment, for example. In this case the display will be permanently angled. Depending on the environment of the device, the ability to make the optical axis depart from the normal to the plane of the display can mean that the display will be easier to view and/or less susceptible to glare.

If a mechanism for traversing in the X and/or Y direction is connected into the display layers A and/or C, then the angle of viewing can be altered dynamically with the device in the field. The display may be adjustable by the use for best viewing. The display may alternatively be connected to a computer with a camera that is observing the viewer, and the display may be re-optimized for angle of view depending on where the viewer is located. Further, a large area display may be configured to continuously track a viewer in a room and to optimize the viewing angle as the viewer proceeds from one task or location to another in the room or area. Among the many possible applications are advertising, for example.

The location of the A and C layers do not have to be in registration along the optical axis of the lens array. For a permanently offset of the display, the layers can be put into a permanent registration of the occultating disks not on the axis of the optical array. For a dynamically alterable display, the A and/or C layers may be incorporated into a structure which allows the entire layer to move in the X and/or Y axis of the display. This motion in the XY plane can allow for offset viewing.

The mechanism needed to dynamically offset the layers A and/or C may be connected to a control device. This control device is expected to operate by means of microprocessor control, but simpler control mechanisms can also be used in accordance with embodiments of the invention.

At the time of display operation, a signal may be sent to the X and Y axis actuators built into the structure of layer A and/or layer C. The selected layer experiences a mechanical movement in the XY plane, with a corresponding movement of the occultating disks relative to the micro-lens array optical axis. Normal operation of the device is expected thereafter.

### An Electromechanical Display Improvement Using a Light Mask

A mechanism for varying the brightness of pixels and improving the contrast as the display is viewed off-axis is needed. Because of the particular optical layout, this effect may exacerbate the normal contrast loss associated with a lens system. An improvement is proposed that substantially improves the off-axis contrast and the on-axis contrast as well.

In one aspect of embodiments of the present, a mask structure can be incorporated into an electromechanical display.

The presence of occultating disks may provide a light regulation mechanism. One characteristic of this approach is that the display may have poor off-axis contrast, but good on-axis contrast. In an effort to improve the off-axis contrast of the micro lens array, a mask may be incorporated into the display pixel. Such mask may be approximately coplanar with the C layer. This mask may have an open diameter substantially identical to the diameter of the occultating disk for a given pixel. When the occultating disk is in the off condition, the disk and mask may substantially obstruct the light from the illumination source in the back of the display (behind layers D and E.) When in the on condition, the occultating disk may be moved away from the mask assembly, and light may be allowed to travel around the edge of the mask and occultating disk.

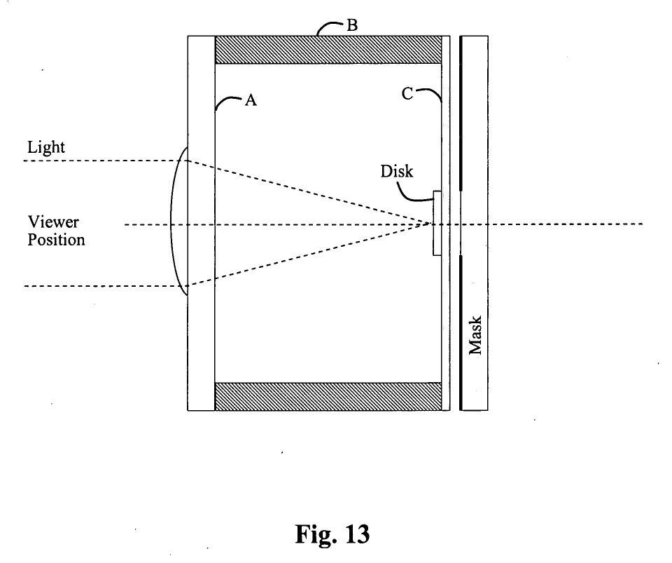

Referring now to FIG. 13, a mask layer is shown along with the display assembly. The mask may obstruct the illumination light source: (i) when the occultating disk is in the off position, thereby improving the on-axis contrast of the black pixel and substantially improving the off-axis contrast as well; and (ii) when the occultating disk is in the on position no adverse effect may be found on the optical performance.

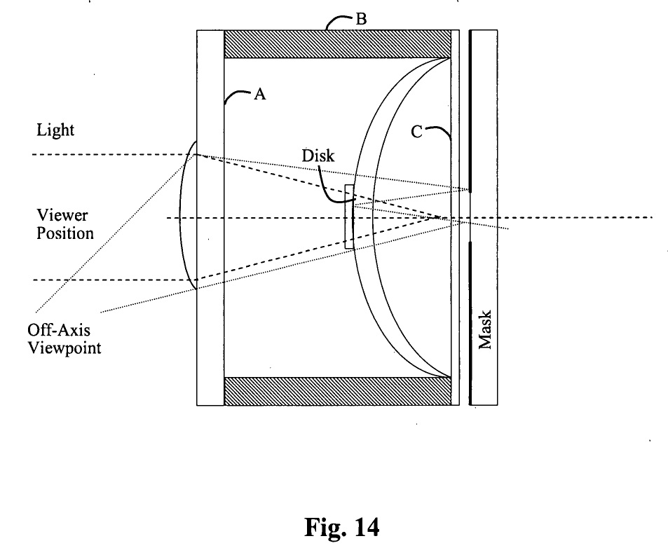

While the mask must be opaque, there are good reasons why it could be advantageously highly reflective. In FIG. 14, the pixel is in the on condition. In this case, the front side (e.g., toward the A layer) of the occultating disk is black, but the back side of the occultating disk (e.g., toward the E layer) can be reflective. In this case, a highly reflective front side of the mask may allow light that is bounced from the illumination source by way of the reflective side of the occultating disk to efficiently traverse to the lens. This both increases the contrast on-axis, but also increases the brightness and accordingly the contrast off-axis.

The mask assembly may be incorporated into a display structure. In one embodiment, the mask may be incorporated between layers C and D or as a part of layer E, or behind, for example.

### Use of Convex and Concave Reflective Surfaces to Enhance Micro-Lens Based Display Technology

A variation to a method and mechanism for a micro-lens array based display technology can include substituting mirror surfaces and/or combinations of lenses and mirror surfaces to create displays having improved qualities. The insertion of the mirror surfaces can be accomplished using changes in the deposition of reflective/conductive surfaces, for example.

On aspect of embodiments of the present invention is the use of catadioptric (e.g., lens plus mirror) elements to create the same functionality as other lens micro-arrays.

Another aspect of embodiments of the present invention is the use of convex reflective elements to expand the angle of view of the display.

Another aspect of embodiments of the present invention is the use of a concave mirror element, which can substitute for or augment another micro lens element.

Another aspect of embodiments of the present invention is the use of non-spherical optics to enhance the off-axis contrast.

According to embodiments of the present invention, the display can use mirrors and, optionally, lenses to perform the light control and dispersion. The introduction of the mirror system allows for more degrees of freedom in the optical design and a potentially better quality display.

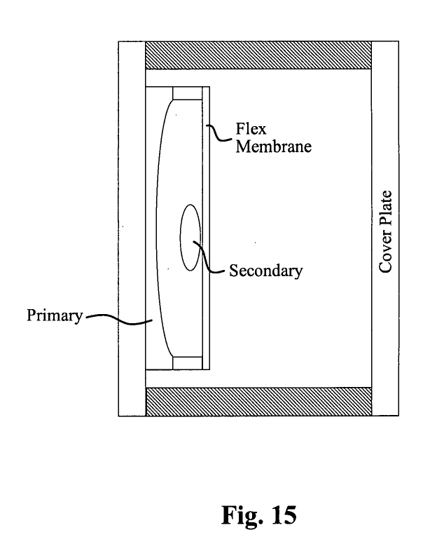

Referring now to FIG. 15, a cross-section of one example of the mirror-based display in its pixel off state is shown. The pixel element can include a primary reflective surface (e.g., main mirror, labeled Primary) and a secondary reflective surface (labeled Secondary). Also, a mask structure may help control scattered light from the main illumination source. Further, the backside of the secondary can alternatively be black or substantially light absorbing.

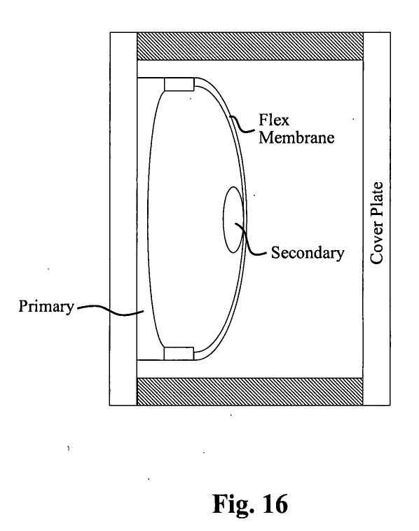

Referring now to FIG. 16, a cross-section of one example of the mirror-based display in its pixel on state is shown. The secondary has been traversed substantially far away from the primary and, accordingly, a light path now exists from the light source to the secondary, then to the primary mirror and out the front of the display. Also, the front of the display may not be open to the air, but may have a cover plate. Such a plate may have value as a protection of the delicate mechanism of the mirror/secondary structure or value in improving the optical performance of the optical array by means of aberration reduction if it is correctly placed, for example.

In one embodiment of the present invention, a primary optical element is the primary mirror. This structure may be most easily fabricated with an optically sensitive polymer material (e.g., SU-8 photosensitive epoxy resin) and a mask material that has a graded opacity from center to edge of the mirror element. The exact optical shape of the mirror is sensitively related to the proper grading of the fabrication mask and some ability for the optical design to tolerate small amounts of manufacturing imperfections may be preferable. The secondary can be created using photosensitive resins, as described above, but can also be created by the process of metal film lift-off, for example.

A system of electrostatic connections on the primary mirror and on the foil that holds the secondary may also be included. The primary mirror can use either reflective materials, such as aluminum, or transparent materials like ITO. The flexible foil can use similar materials, depending on the optical efficiency needed. An illumination source located behind the primary mirror can complete the pixel design.

### On the Creation of a Novel Micro Electromechanical Switch Structure for Applications Including Displays and Display Backplanes

For a MEM switch array created with polymer foils for applications like display backplanes, there is an underlying observation that the switch cell uses electrostatic attraction to pull the switch into an ON state and that elastic energy stored in the stretched polymer film provides the power to return the switch to the OFF state. The use of both mechanical and electrostatic force to change the state of the switch has many advantages including lower cost drive circuitry and simple manufacturability. It has been noted however that the optimal solution of the balancing of the electrostatic and mechanical forces sometimes compels a cell design with certain qualities, like thin polymer foils, or narrow gaps between foils. In order to address the issues presented by cell designs that strain manufacturability and to provide wider tolerances for normal use constraints, a new class of switch cells is disclosed as follows.

The primary object of this invention is the creation of a class of MEMS switch cells that use electrostatic attraction to pull the switch into both the ON and the OFF state.

Another object of this invention is the creation of a class of MEMS switch cells that are more tolerant of manufacturing variations than previous designs.

Another object of this invention is the creation of a class of MEMS switch cells that are significantly less sensitive to the planarity of the substrate.

Another object of this invention is the creation of a class of MEMS switch cells that are significantly optimized for use in displays that must be flexible.

In one embodiment of a MEM switch design, the flexible foil of the switch (identified across all previous applications as the C layer) is under tension. The tension assured that the foil was able to store a predictable quantity of elastic energy, and that the mechanical pull back of the switch contacts to the OFF state would reliably take place. A consequence of the use of a tense foil is the observation that the switch cell has a limited ability to tolerate non-planarity of the substrate. As the A and E structures bend, the C foil remains planar, and it does not take a great deal of bending for the C foil to contact the A or E layer. The function of the switch cannot be assured when the C foil is so displaced.

During these investigations it was noted that a class of switch cells that do not store elastic energy in the C foil could be constructed. These designs required that the C foil be electrostatically pulled from the ON to the OFF state and vice versa, but there is no requirement for balancing the electrostatic and mechanical energies, as in previous designs. While this class of switch cell designs does require separate (or at least elaborated) drive electronics for pulling them into the ON or OFF state, the amount of power needed for the switch transition is much reduced. This power reduction can be used either to reduce the total power of the FASwitch array, or can be used to speed up the switching speed of the display. Either is highly desirable, depending on the display application.

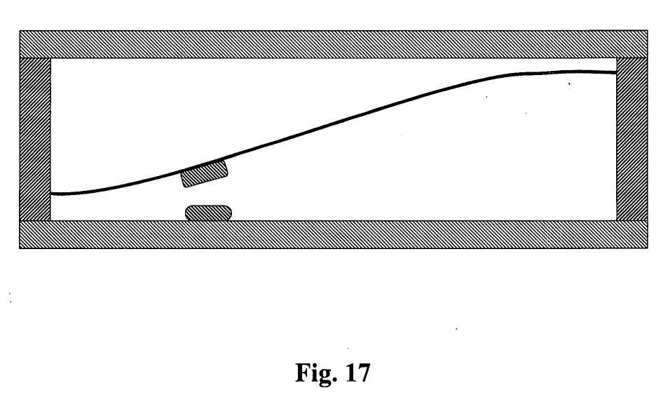

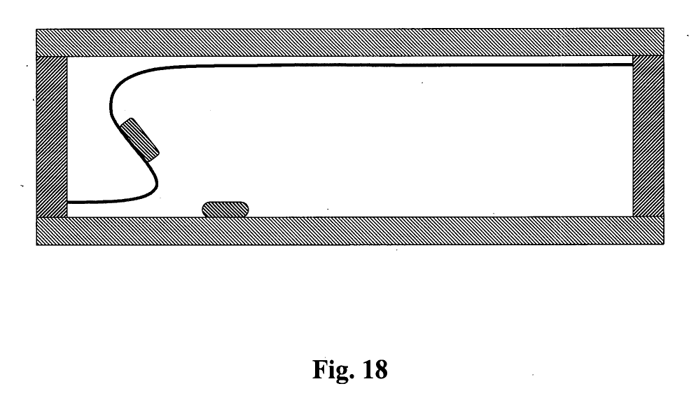

This class of switch designs is characterized by a C layer that is not under tension. The two representative cell designs to be discussed, called respectively the Low Tension Cell (LTC) (FIG. 17) and the S-cell (FIG. 18) share several desirable qualities. Each uses electrostatic attraction between polymer foils that are in exceedingly close proximity. In this way the magnitude of the electrostatic attraction is maximized. They have lower gas-elastic dampening, compared to previous designs, allowing for faster switching times. The designs relax some or substantially all of the previous requirements for substrate planarity.

The LTS will de described first, and from the information presented, the somewhat less obvious S-cell will presented.

### LTS

The LTS is presented in cross-section in FIG. 17. In the LTS, there is an extra set of electrostatic plates on the E layer and on the Cb side of the C layer, compared to previous designs. In addition there is no tension in the C layer, in fact this layer is slack. As designed, the length of material in the C layer exceeds the dimensions of the cell by just that amount needed to allow the electrostatic plates on both the A and the E layers to pull the C layer out of contact with the complimentary layer. Typically a cell length and some fraction of the cell gap in length.

Notice that the same zipping action described in another embodiment describing the pinch-cell design, is at work here. The same advantage of the zipping action, that is that the electrostatic force is very high because of the proximity of the two electrostatic plates, is evident here. This was a big advantage in the pinch-cell design, and is even more so here because the same zipping action that caused the pinch-cell to close its contact and create an ON conditions, is being used in the LTC to also turn OFF the switch.

The fact that the C layer is being caused to traverse from the A to the E layer by electrostatic forces caused by the film areas in close proximity also have the effect of allowing a design which separates the E and A layer from each other to an extent difficult to create in previous electro-mechanical cell designs. The ability to increase the separation the A and E layer from each other decreases the sensitivity of the design to manufacturing variations and upon further thought, is seen to completely eliminate the design sensitivity to substrate flatness. Both are significant improvements over previous designs.

### S-Cell

In FIG. 18, the S-cell is shown in cross-section. The disposition of electrostatic plates and contacts is the same as in the LTC design, but the C layer is disposed in an S shape within the cell confines. It is proposed that the motion of this cell design is substantially similar to that of the LTC design, but for these differences. The C layer is displaced in an X direction to a greater extent than in the LTC design when switching from ON to OFF state. The spacing between the A and E layer can be greater. The contact is not only displaced from the surface of the A layer in the OFF condition, but may assume a substantial angle relative to the base contact on the A layer. The gas displacement of the switch in switching is much less drag-inducing than that for the NTC design.

### Connections

In addition to the connections to drive circuitry previously described for FASwitch arrays, this technology requires an extra drive circuit to actively pull back the cell into the OFF condition. This circuit is coordinated with the original drive circuit.

It is also noted that by having both sets of drive circuits active at the same time, thereby allowing the C layer to be tensioned to a desirable amount, that many of the manufacturing and environmental effects that could cause operation variations can be eliminated.

### Operation

The operation of the LTC and the S-cell use substantially the same ON-side drive scheme described for the previous technology exemplars. The OFF state is driven by a separate circuit, coordinated with the ON state drivers and act to electrostatically pull the cell into the OFF state, or to regulate the tension in the C layer during operation.

For those skilled in the art, the operation of this cell is easily appreciated after examination of our previous electrostatic cell designs.

Attached hereto is an Appendix illustrating the basic MEMS switch design, manufacturing techniques and applications in accordance with the various embodiments disclosed herein.

In the description herein for embodiments of the present invention, numerous specific details have been provided, such as examples of components and/or methods, to provide a thorough understanding of embodiments of the present invention. However, embodiments of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

With the present invention, it will be appreciated that it is possible to replace the silicon-on-glass thin film transistors (TFT) based backplanes with a matrix of MEM switches that are readily manufactured using inexpensive manufacturing equipment and printing process techniques. Further, it will be appreciated that the present invention enables the manufacture of scalable large optical displays on rigid or flexible plastic membranes at low cost that have an adequate and useful lifetime. Further still, the present invention enables the manufacture of optical displays that may be flexed or twisted into novel shapes while still maintaining the display properties.

There are many existing products, and potentially a large number of new products, that will benefit from an array of switches laid out in matrix pattern (sometimes uniform, sometimes not, depending on the application). With the present invention, it is possible to use the opened (or closed) switch to activate a variety of devices so needing such a switch.

With the present invention, the array switches may include one or more of the following attributes: (a) may be physically scaled depending on the application, (b) may switch either AC and/or DC voltages, (c) may switch either high or low voltage, (d) may switch high or low current, and (e) may be either a momentary or latched switch. The most common need for such an array today is for flat panel displays to replace the expensive backplane based on silicon transistors layered onto glass substrates.

It will further be appreciated that one or more of the elements depicted in the drawings/figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, further embodiments may include various display architectures, biometric sensors, pressure sensors, temperature sensors, light sensors, chemical sensors, X-ray and other electromagnetic sensors, amplifiers, gate arrays, other logic circuits, printers and memory circuits.

Additionally, any signal arrows in the drawings/Figures should be considered only as exemplary, and not limiting, unless otherwise specifically noted. Furthermore, the term or as used herein is generally intended to mean and/or unless otherwise indicated. Combinations of components or steps will also be considered as being noted, where terminology is foreseen as rendering the ability to separate or combine is unclear.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, Field of the Invention, Title, or Summary, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A switch comprising:
a first flexible surface;
a second surface angled relative to the first surface; and
a first terminal and a second terminal positioned relative to the first flexible surface and the second surface so that selective flexing of the flexible surface electrically couples or uncouples the first terminal to the second terminal.

2. The switch of claim 1, further including:
first means for selectively actuating the flexible layer.

3. The switch of claim 2, wherein the first means further includes:
second means for selectively applying an electrostatic force between the first flexible surface and the second surface.

4. The switch of claim 3, wherein the first surface is positioned on a first elastic flexible layer, and wherein the second surface is positioned on a second layer.

5. The switch of claim 4, wherein the first flexible layer includes:
a polymer material.

6. The switch of claim 4, wherein the second means further includes:
a first actuator electrode coupled to the first surface and a second actuator electrode coupled to the second surface.

7. The switch of claim 6, wherein the first actuator electrode has a modulus of elasticity that is similar to the modulus of elasticity of the first flexible layer.

8. The switch of claim 6, wherein the second actuator electrode is positioned in proximity to the first flexible layer so that selective application of voltage to the first actuator electrode and/or the second actuator electrode causes a charge differential between the first actuator electrode and the second actuator electrode, wherein the charge differential is sufficient to attract the first electrode to the second electrode, thereby flexing the flexible layer toward the second layer.

9. The switch of claim 6, further including:
a light-emitting unit coupled between the second terminal and a third terminal that is selectively coupled to the second terminal by the first terminal in response to actuation of the first layer.

10. The switch of claim 4, further including:
a third layer disposed on one side of the first layer, the second layer being positioned on a side of the first layer that is opposite the third layer.

11. The switch of claim 10, further including:
a support structure separating a portion of the first layer and a portion of the second layer.

12. The switch of claim 11, wherein the support structure includes:
walls that at least partially define a cell within which the first terminal and the second terminal are positioned.

13. The switch of claim 12, wherein the walls are positioned to further separate the third layer from the second layer at the walls.

14. The switch of claim 12, further including:
a protrusion extending from the third layer between the walls, wherein the protrusion indents the first layer.

15. The switch of claim 14, further including:
an electrical contact coupled to the flexible layer in a position so that actuation of the flexible layer may cause the electrical contact to electrically couple the first terminal to the second terminal.

16. The switch of claim 15, wherein a wedge-shaped space is defined between the first and second surfaces, wherein the protrusion presses the first layer against the second layer at a narrowest portion of the wedge-shaped space.

17. The switch of claim 14, wherein the protrusion partitions a first portion of the switch and a second portion of the switch, wherein the first and second portions of the switch may act as independent switches, having a first set of actuator electrodes and terminals and a second set of actuator electrodes and terminals, respectively.

18. The switch of claim 17, wherein the protrusion is sufficiently shaped and sized to increase an ability of the switch and accompanying independent switches to withstand bending of the switch.

19. The switch of claim 18, further including:
plural of the switches coupled to light-emitting units, forming a substantially flexible display.

20. A switch comprising:
a first flexible layer;
a first actuator electrode disposed on the first flexible layer;
a first contact electrode disposed on the first flexible layer;
a second layer;
a second actuator electrode disposed on the second layer;
a second contact electrode disposed on the second layer; and
a support structure between the first flexible layer and the second layer so that the first contact electrode will contact the second contact electrode upon activation of the first actuator electrode and/or the second actuator electrode.

21. The switch of claim 20, wherein the support structure includes:
sidewalls of a cell formed between the first flexible layer and the second layer.

22. The switch of claim 21, wherein the first flexible layer and the first actuator electrode have similar moduli of elasticity.

23. The switch of claim 21, wherein the sidewalls include:
perforations therein.

24. The switch of claim 21, wherein the support structure further includes:
a protrusion that indents the flexible layer, thereby causing a portion of the flexible layer to extend closer to and/or to contact the second layer, thereby increasing electrostatic force between the first flexible layer and the second layer in response to a predetermined electrical charge differential between the first actuator electrode and the second actuator electrode.

25. The switch of claim 24, wherein the protrusion causes the first flexible layer to include one or more surfaces that are angled relative to the second layer.

26. The switch of claim 24, wherein the protrusion is connected to a third layer.

27. The switch of claim 24, further including:
a third contact on the second layer, wherein the third contact is positioned so that actuation of the first flexible layer via the first actuator electrode and/or the second actuator electrode causes the first contact electrode to electrically connect the second contact electrode to the third contact electrode.

28. The switch of claim 27, wherein after the first actuator electrode and the second actuator electrode cause actuation of the first flexible layer thereby electrically coupling the second and third contact electrodes, then application of sufficient voltage to the second contact electrode will cause a light-emitting unit coupled to the third contact electrode to emit light.

29. The switch of claim 24, wherein the protrusion divides the cell into a first cell portion and a second cell portion that include a first set of actuator electrodes and contact electrodes and a second set of actuator electrodes and contact electrodes, respectively.

30. The switch of claim 29, wherein the first cell portion and the second cell portion are coupled to a first light-emitting unit and a second light-emitting unit, respectively.

31. The switch of claim 30, wherein the first light-emitting unit and the second light-emitting unit are coupled to the first set of contact electrodes and the second set of contact electrodes respectively, so that selective actuation of the flexible layer and selective application of voltage to contact electrodes in the first set of contact electrodes and the second set of contact electrodes cause selective activation of the first light-emitting unit and the second light-emitting unit, respectively.

32. The switch of claim 31, further including:
plural cells coupled to plural light-emitting units to form a display, wherein each of the plural cells are coupled to one or more controllers for selectively actuating flexible layers of the cells and activating accompanying light-emitting units to create a desired image.

33. A switch comprising:
a flexible layer;
a first terminal; and
a second terminal, wherein the first terminal and the second terminal are positioned relative to the flexible layer so that selective flexing of the flexible layer electrically couples or uncouples the first terminal to the second terminal.

34. The switch of claim 33, further including:
an electrical contact coupled to the flexible layer in a position so that actuation of the flexible layer may cause the electrical contact to electrically couple the first terminal to the second terminal.

35. The switch of claim 34, further including:
a light-emitting unit coupled between the second terminal and a third terminal.

36. The switch of claim 34, further including:
first means for selectively actuating the flexible layer.

37. The switch of claim 36, wherein the first means includes:
a first electrode positioned on a surface of the flexible layer;
a second electrode positioned on a second layer in proximity to the flexible layer so that selective application of voltage to the first electrode and/or the second electrode cause a charge differential between the first electrode and the second electrode, wherein the charge differential is sufficient to attract the first electrode to the second electrode, thereby flexing the flexible layer toward the second layer.

38. A switch comprising:
a first terminal;
a second terminal;
a membrane;
first means for generating an electrostatic force; and
second means for employing the electrostatic force to actuate the membrane to selectively couple the first terminal to the second terminal.

39. The switch of claim 38, further including:
a support structure separating a second layer from the membrane at a perimeter of the cell and a protrusion indenting the membrane within the perimeter, yielding an indented membrane in response thereto.

40. The switch of claim 39, wherein the protrusion is adapted to facilitate operation of the first means.

41. The switch of claim 39, wherein the indented membrane includes:
a surface that is angled relative to the second layer.

42. The switch of claim 41, wherein the membrane and the second layer include selectively placed actuator electrodes for facilitating producing electrostatic forces sufficient to bend the membrane toward the second layer so that a contact pad on the membrane bridges terminals positioned on the second layer or so that terminals positioned on the membrane are bridged by a contact pad on the second layer.

43. The switch of claim 42, wherein the actuator electrodes are positioned on the membrane and the second layer so that indentation caused by the protrusion brings the electrodes closer together, thereby enhancing electrostatic forces.

44. The switch of claim 43, wherein the protrusion is sized, shaped, and positioned relative to the support structure so that the protrusion enhances an ability of the switch to withstand bending.

45. The switch of claim 44, wherein the second means includes:
a controller.

46. A switch comprising:
first means for generating an electrostatic force and
second means for employing the electrostatic force to actuate a flexible membrane to selectively couple a first terminal to a second terminal.
